(19) United States
(12) Patent Application Publication
(10) Pub. No.: US 2002/0142123 A1
(43) Pub. Date: Oct. 3, 2002

(54) Belt-shaped body and article-accommodating body using the belt-shaped body

(76) Inventors: Yoshiharu Yamaguchi, Toyama-ken (JP); Yutaka Yokoyama, Toyama-ken (JP); Akio Yunoki, Toyama-ken (JP); Yoshimichi Yamakita, Toyama-ken (JP); Tsutomu Hamatani, Toyama-ken (JP); Sadaji Okeya, Toyama-ken (JP); Takayuki Hasegawa, Toyama-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/059,026

(22) Filed: Jan. 30, 2002

(30) Foreign Application Priority Data
Jan. 31, 2001 (JP) 2001-23351
Feb. 5, 2001 (JP) 2001-28696
Feb. 22, 2001 (JP) 2001-47056

(51) Int. Cl. B32B 3/00

(52) U.S. Cl. 428/58; 428/102

(57) ABSTRACT

In a belt-shaped body where plural coupling elements are fixed along a periphery of a long tape main body, when a width of the tape main body is W, dimension from a first coupling position center of said coupling elements up to an end face in the length direction of the tape main body near said is a′ and the number of tape windings except top/bottom faces thereof is N, a length L′ in the length direction of the tape main body is obtained according to the following expression (I):

$${L}^{′} = ( 1 + \frac{α}{100} ) [ K \{ \frac{{a}^{′}}{βcos ( {tan}^{- 1} \frac{ωβ}{{a}^{′}} )} - AT \} - 2 NBW ]$$

Where α is a contraction coefficient of the tape main body when the coupling elements are mounted;

β is a correction value;

K is a value determined depending on a configuration of an article-accommodating body obtained from the belt-shaped body;

T is dimension between linking members at a first linkage position;

A is (2−π)/2π; and

B is (2−π)/4.

### BACKGROUND OF THE INVENTION

1. Field of the Invention

The present invention relates to a belt-shaped body capable of obtaining an article-accommodating body by winding the belt-shaped body spirally about a center of a predetermined position thereof. More particularly, it relates to a belt-shaped body in which a vertex of the article-accommodating body is not deflected and which can be used in a reversed manner and has an excellent appearance and further can be provided with a suspending device formed integrally therewith. Further, it relates to an article-accommodating body which can be obtained from the belt-shaped body.

2. Description of the Related Art

Conventionally, Japanese Utility Model Application Laid-Open No. 62-174416, Republic of China's announcement No. 084688, U.S. Pat. No. 4,710,983 and the like have disclosed knowledge that coupling elements of a slide fastener or snap-coupling type male/female coupling elements are fixed along a substantially entire periphery of a thick fiber woven/knitted tape having a stiffness except separating portions thereof so that the opposing coupling elements are engaged by winding the tape spirally so as to obtain a triangular pyramid or cylindrical accommodating body.

According to these publications, diversified configurations such as a triangular pyramid shape, a rectangular shape, a cylindrical shape and the like can be obtained by changing a length of said belt-shaped body or a position in which the coupling elements are first engaged. Further, according to the Republic of China's announcement, buttons which engage with and disengaged from each other are fixed at an end portion and an intermediate portion of a tape main body. When it is intended to form such a flat box type bag or the like and its storage depth is made to be shallow, the button fixed at a front end of the tape main body portion is fastened to a mating button fixed midway of the tape main body by adjusting a winding amount of the tape main body. When it is intended to form a strap of a bag or the like to obtain a maximum storage depth for the article, an accommodating body is obtained using its entire length of the tape without forming any strap.

Further, according to Japanese Utility Model Publication No. 62-16891, of the coupling elements fixed along both the side edges of the aforementioned tape main body, the coupling elements to be fixed along one side edge thereof are fixed halfway on a side of an end edge of the tape main body. Then, the coupling elements to be fixed along the other side edge thereof are shorter than a fixing end portion of the coupling elements fixed along said one side edge thereof. Then, the tape main body is folded by approaching the fixing end portion of the coupling elements fixed along said one side edge to the fixing end portion of the coupling elements fixed along the other side edge, and the other side edges without such fixed coupling elements are integrated by sewing. Further, an end portion of the tape main body on which the coupling elements are not fixed is folded in a length direction thereof and the front end is fixed so as to be bound with the tape main body. Thus, a loop-like strap is formed at an end portion of the tape main body.

With such a structure, an article-accommodating body is formed by engaging the opposing coupling elements while winding the tape main body spirally from an end portion thereof opposite to the loop-like strap portion. Consequently, the loop-like strap portion is disposed at the formed end portion, so that the strap is automatically formed at the same time when an article-producing opening is closed.

However, the accommodating bodies disclosed in those publications have been invented mainly for the reason for unexpectedness that it can be obtained by engaging the coupling elements fixed continuously along the periphery of the belt-shaped body having the above-mentioned structure in succession. Therefore, the belt-shaped body has no special function more than being used as a waist belt. Thus, people's interest for such unexpectedness is likely to be lost in a short time and it does not lead to a continuous application, so that such accommodating bodies have not yet reached their practical level.

This kind of article-accommodating body presents a triangular pyramid, a rectangular or rectangular cylindrical shape. Therefore, this accommodating body has a vertex at its all corners. Meanwhile, these accommodating bodies are formed by after linking linkage members such as releasable bottom end stop, which is a bottom end stop device of a slide fastener, disposed at a predetermined interval from an end of a long belt-shaped body having a plurality of coupling elements along its periphery, winding the belt-shaped body spirally around the linking portion so as to engage the opposing coupling elements in succession.

For the reason, if the belt-shaped body is too long or too short, the end portion of the belt-shaped body remains or a desired configuration cannot be secured. More specifically, the vertex at the corner of the accommodating body is shifted or the configuration is twisted, so that the accommodating body gets out of shape. Because this product intends to aim at achieving such unexpectedness and fashion performance that the article-accommodating body can be created from the belt-shaped body only by engaging the coupling elements, losing of such unexpected design in appearance is fatal.

Particularly, because the configuration is stabilized either, there is a doubt in function as the accommodating body as well as the appearance unexpectedness, so that an interest in use thereof is lost in a short time. Thus, it could not lead to a continued utilization or a wide-spread use.

As for the accommodating body with a strap disclosed in the above-described Republic of China's announcement, if it is intended to form a strap, the lid portion (article-producing-introducing opening)of this accommodating body remains open unless a special opening/closing structure for closing the lid portion is applied, as indicated in the Japanese Utility Model Publication No. 62-16891. Further, if the coupling elements are engaged up to an end of the tape main body, only an accommodating body having substantially the same configuration as the accommodating bodies disclosed in the above-mentioned other publications can be obtained.

On the other hand, as for the tape main body according to the Japanese Utility Model Publication No. 62-16891, although an accommodating body having the same configuration as the above-described conventional accommodating bodies can be obtained by engaging the coupling elements successively while winding the tape main body spirally, even if engagement of the coupling elements is released, this accommodating body does not restore its shape to a straight tape main body, but a loop-like strap portion is still left. Further, a ship-shaped portion remains along an inside of the tape main portion in a length direction thereof from that strap portion, so that this cannot be set up neatly during non-use or at the time of shipment. Further, even if it is intended to return the shape to a tape main body for applying it to the other purposes such as an ordinary belt or a neck strap, the product can not bear that application.

Further, because in such conventional belt-shaped bodies, a tape portion of a slide fastener is fixed to a rear face of a periphery of the tape by sewing, or snap buttons are mounted so as to correspond to the front and rear surfaces of the tape, the front and rear surfaces are distinguished clearly. Thus, if it is intended to use as an article-suspending device by itself such that it is suspended from a neck or a shoulder, the rear face may be exposed to the front side, thereby deteriorating its appearance.

In a process of forming the article-accommodating body by engaging the coupling elements fixed along the periphery of the belt-shaped body successively while winding it spirally, the front and rear sides are automatically determined. Thus, only a singular accommodating body can be obtained, so that a pattern or colors exposed on the front surface of the accommodating body is only one kind. Therefore, it is not possible to use the accommodating body in various ways.

### SUMMARY OF THE INVENTION

Accordingly, the present invention intends to solve the above-described problems and provide a belt-shaped body and an accommodating body using the same, which does not depend on a mere unexpectedness as the belt-shaped body but has an excellent appearance and a stabilized configuration and in which at the same time when the accommodating body is formed, a suspending device can be automatically formed, and even if any one of the front surface and rear surface is used, the front and rear surfaces of different colors or patterns can be obtained, thereby allowing use of both sides of the accommodating body without any problem in appearance viewpoints.

The present invention provides a dimension and a shape of an article-accommodating body to be obtained based on a dimension and a shape of a belt-shaped body. Further, the present invention provides a dimension and a shape of a belt-shaped body to be obtained based on dimension and shape of an accommodating body intended to be obtained.

Specifically, according to a basic feature of the present invention, in the belt-shaped body in which a plurality of the coupling elements are fixed along a periphery of a long tape main body, when a tape width of a tape main body is W, a dimension from a first coupling position's center of the coupling elements up to an end face in a length direction of the tape main body near said position is a′ and the number of tape windings except top/bottom faces is N, a length L′ in the length direction of the tape main body is obtained according to the following expression (I):

$${L}^{′} = ( 1 + \frac{α}{100} ) [ K \{ \frac{{a}^{′}}{βcos ( {tan}^{- 1} \frac{ωβ}{{a}^{′}} )} - AT \} - 2 NBW ] \qquad ( I )$$

Where α is a contraction coefficient of the tape main body when the coupling elements are mounted;

β is a correction value;

K is a value determined depending on the configuration of an article-accommodating body obtained from a belt-shaped body; p1 T is a dimension between linking members at a first linkage position;

A is (2 −π)/2π; and

B is (2 −π)/4.

Further according to a basic structure of another aspect of the present invention, the accommodating body is formed by engaging the corresponding coupling elements along the periphery of the belt-shaped body successively while winding that long belt-shaped body spirally around the center of the coupling elements at an initial engaging position. When a tape width of tape main body is W and a lateral length of a side of the accommodating body as viewed from its front is a, a distance a′ from the center of the coupling elements at the initial engaging position up to an end face of a tape main body near the initial engaging position and a necessary tape main body length L′ are obtained by the following expressions (II) and (III):

a′=βa (II)

L′=(1+α/100)(XD+2NE)a (II)

Where α is a contraction coefficient of the tape main body when the coupling elements are mounted;

β is a correction value;

N is the number of windings excluding top/bottom faces of the article-accommodating body;

D and E are constants;

X is 1.5 or 2; and 0<W<a.

To obtain an article-accommodating body having a desired dimension and shape stabilized in appearance and design, the following matters have been considered. A first matter is from where engagement of the coupling elements is to be started, that is, to specify a winding start position of the belt-shaped body. Second, the configuration of the accommodating body is changed to a triangular pyramid or a rectangle depending on the winding start position and the length of the belt-shaped body. Third, the length of the belt-shaped body is changed depending on the material and the structure of the tape main body. Fourth, it is more influenced when the coupling elements are mounted to the periphery of the tape main body, especially by sewing. Fifth, the configuration of the tape main body, particularly, a change in the configuration of the end portion when the belt-shaped body is produced should be considered.

There are other factors such as a width of the tape main body, a dimension between opposing faces of linking members such as a releasable bottom end stop and a snap button, which are mounted at the winding start position of the belt-shaped body, and a number of windings of the belt-shaped body. These factors also affect largely a finished configuration of the article-accommodating body. Further, when the coupling elements are previously fixed to a narrow tape strip to and are then attached to the periphery of the tape main body via this tape strip, a protrusion amount of that tape strip from the tape main body needs to be considered.

Next, the way for introducing the above-described expressions (I), (II) and (III) will be described.

A purpose of the expression (I) is to obtain an accommodating body having a desired size and shape by determining a tape length L′ that can be actually obtained by cutting. The expressions (II) and (III) intend to obtain a tape length L′ of a tape main body that is actually necessary from the shape and the dimension of an accommodating body to be obtained. Hereinafter, two embodiments about a rectangular or a cylindrical accommodating body and a regular triangular pyramid accommodating body will be described.

In order to calculate a tape length L′ to obtain a rectangular accommodating body 30 as shown in FIGS. 2 to 4, it is considered that an accommodating body 30 is divided into some portions.

Reference numeral 8a denotes a tape portion of a bottom face and a top face. The tape length of a side thereof is assumed to be L₁. Reference numeral 8b denotes a side of an intermediate portion of the tape portion. The tape length of that side is assumed to be L₂. Further, a radius of an arc-shaped end portion of the tape main body 2 as viewed from the bottom face shown in FIG. 4 is assumed to be R while a radius of an arc shape on the engaging start side of the coupling elements 3 is assumed to be r. Further, it is assumed that the width of the tape to be used is W, a dimension between linkage members which are engaged first as shown in FIG. 1 is T, and a dimension from the center (central position) between the linkage members up to an end face in the length direction of the tape main body 2 near that position is a′. Then, theoretical L₁ and L₂ can be obtained as follows.

Here, there is a relationship that T=2πr/2=πr and if it is assumed that a tape winding gradient of the bottom face portion is θ, it comes that θ=tan⁻¹ (W/a) and therefore, the theoretical tape lengths L₁, L₂ can be calculated as follows.

$$\begin{matrix}{L}_{1} = a / cos θ - r + 2 π r / 4 \\ = a / cos θ - T / π + T / 2\end{matrix}$$

$$\begin{matrix}{L}_{2} = a / cos θ - R - r + 2 π R / 4 + 2 π r / 4 \\ = a / cos θ - W / 2 - T / π + π W / 4 + T / 2\end{matrix}$$

Therefore, theoretically, the entire length L of the tape main body 2 is as follows:

L=XL₁+2NL₂ (IV)

Where N is the number of windings of the belt-shaped body excluding the top and bottom faces of the article-accommodating body; and

X is 1.5 or 2.

However, if it is intended to sew a tape strip having coupling elements to the periphery of the tape main body 2 or integrally mount various kinds of the coupling elements made of synthetic resin along the periphery of the tape main body 2 by molding, contraction occurs in the tape main body. If this contraction is ignored, not only a desired configuration cannot be obtained but also the function of the accommodating body 30 is lost. For this reason, a contraction length which occurs when the coupling elements are mounted with respect to the entire theoretical length L of the tape main body 2 needs to be considered. This contraction length (contraction coefficient) varies depending on the material and the structure of the tape main body 2. For example, a difference in contraction coefficient between a thick tape and a thin tape made of an ordinary fabric is more than 3%. Even in the case of mesh fabric, such a difference is 0.2 to 1.1% depending on the size of the mesh. Therefore, its preferable value is in a range of 0.2 to 6.0%.

Further, the entire length of the tape main body 2 needs to be corrected depending on the configuration of an accommodating body 30 to be obtained (a regular triangular pyramid, a rectangular case, a cylindrical case), besides the above-described matter about the contraction. This correction value β is a ratio between a dimension a′ from the center of the first coupling position of the coupling elements 3 up to an end face in the length direction of the tape main body 2 near the position and a lateral width a as viewed from the front side of an actually obtained accommodating body 30. In the expression (I), this value is calculated according to a′=β a. This correction value β becomes larger when it is intended to obtain a cylindrical case shaped accommodating body 30, as compared with the other regular-triangular-pyramid or rectangular case shaped accommodating body. The value is in a range of 1.01 to 1.20 and selected arbitrarily depending on the configuration of the accommodating body 30 to be obtained. Unless this correction value β is determined accurately, the rectangular case shaped accommodating body 30 can not be a rectangular but is twisted.

Therefore, when it is assumed that in the rectangular case shaped accommodating body 30, the tape length of a side of a tape portion on bottom and top faces thereof that is actually necessary is L′₁ and the tape length of a side of an intermediate portion thereof is L′₂,

L′₁=a′/(β cos θ′)−T/π+T/2

L′₂=a′/(β cos θ′)−W/2−T/π+πW/4+T/2

If the contraction coefficient a at the time of mounting the coupling elements 3 is considered, the total length L′ {=(XL′₁+2NL′₂)×(1+a/100)} that is actually necessary turns to the above-described expression (I), where the gradient θ after the correction is θ′=tan⁻¹ (Wβ/a′). Here, in the case of the rectangular case shaped accommodating body as shown in FIG.2, if it is assumed that the top face and bottom face have the same dimension and shape, the number X of the tape portion of the top and bottom faces is 2 and the number N of windings of the tape at the intermediate portion is 1.5.

When obtaining the total length of the tape main body necessary for obtaining the regular triangular pyramid accommodating body 31 shown in FIG. 5, it is assumed that the accommodating body 31 is divided to some components similarly to a case for obtaining the total length L′ of the tape main body 2 necessary for obtaining the rectangular case shaped accommodating body 30.

As shown in FIG. 6A, engagement of the coupling elements is released from a final engaging portion of the coupling elements 3 located at the vertex of the regular triangular pyramid accommodating body 31 around a first end portion of the belt-shaped body 1 until it comes to a position beyond the line X-Y as shown in FIG. 6B. When this disengaged portion is unfolded and a remaining accommodating body portion is crushed to be flat such that the line X-Y becomes both side edges thereof, when it is viewed from its top, entirely a rectangular shape is presented like the above-mentioned rectangular case shaped accommodating body 30 and a tape portion having a length of ½ L₁ is extended from an upper corner of the belt-shaped body 1, as shown in FIG. 7.

This extended tape portion is a portion for determining the final shape of the accommodating body 31. Thus, if this portion is considered to be a top face, its length is ½ the length of the top face of the above-mentioned rectangular case shaped accommodating body 30. Therefore, if it is intended to obtain the regular triangular pyramid accommodating body 31, X in the expression (I) is set to be 1.5, so that all the other values are fit. Meanwhile, the number N of tape windings excluding the top and bottom faces is 3.

On the other hand, when obtaining the total length L′ of the tape main body 2 for obtaining the accommodating bodies 30, 31, if a lateral length a as viewed from the front side when the accommodating bodies 30, 31 are crushed to be flat, a tape width W, a winding gradient θ, a contraction coefficient α of the tape main body 2 when the coupling elements are mounted, and a correction value β are determined preliminarily, the expressions (II) and (III) can be obtained. D and E in these expressions (II) and (III) are constants of D=L₁/a, E=L₂/a, which are values that can be determined depending on the dimension and shape of the accommodating bodies 30, 31. Meanwhile, in the case of the cylindrical accommodating body 30, a stabilized configuration of the accommodating body 30 with little twisting can be obtained as long as D is in a range of 1.00 to 1.20 and E is in a range of 1.07 to 1.50. In the case of the regular triangular pyramid accommodating body 31, a stabilized configuration of the accommodating body 31 without any deflection of the vertex can be obtained as long as D is in a range of 1.00 to 1.14 and E is in a range of 1.07 to 1.10.

As long as the respective factors adopt values satisfying the expression (I) or (II) and (III), a stabilized configuration without deflection or getting out of shape at the vertex of the corner portion can be obtained in the article-accommodating body obtained from the belt-shaped body and the obtained accommodating body is very close to a regular triangular pyramid or a regular rectangular. Further, no excessive force is applied to the belt-shaped body when the respective coupling elements are engaged or disengaged, and an article-accommodating body can be produced and restored to the belt-shaped body by a very smooth operation. Therefore, durability of this accommodating body is enhanced, so that it is capable of bearing long term use.

The belt-shaped body of the present invention has a basic structure which is conventionally well known. That is, this belt-shaped body is comprised of a tape main body having a predetermined length and coupling elements disposed continuously along its entire periphery. Yarn to be used for the tape main body may be spun yarn composed of ordinary natural fiber or synthetic fiber, multifilament yarn or monofilament yarn, so that it should not be restricted to any particular one. Generally, monofilament has a higher stiffness than the other fiber yarn if the yarns have the same thickness. If this yarn is applied as composing yarn of knitted/woven fabric, the fabric in which the monofilament is knitted or woven has an increased stiffness in a length direction of the filament, so that the configuration of the knitted/woven fabric in that direction is stabilized. According to the present invention, if monofilament is knitted or woven positively to form knitted/woven fabric containing meshed gaps such that the monofilament extends in a width direction of the tape main body, the configuration in the width direction of the belt-shaped body is stabilized. If the multifilament or ordinary spun yarn is employed as yarn to be used in the length direction of the belt-shaped body, a necessary flexibility can be secured.

As the coupling element, a coupling element to be attached to an ordinary slide fastener, a snap button made of synthetic resin or metal having an ordinary structure, or a snap engaging device, which is comprised of a combination of socket-like and plug-like coupling elements, can be applied. In the snap engaging device, a male or a plug-like engaging element is snap engaged with a female or a socket-like engaging element by pressing or insertion. As the other coupling element, it is possible to employ a so-called surface fastener which comprises male/female engaging elements of a plurality of fine hook pieces and loop pieces. In the surface fastener, one side engaging member and another side engaging member, each composed of a plurality of male and/or female engaging elements, are joined through a plane by pressing the respective engaging faces.

The above constant K that is determined depending on the configuration of an article-accommodating body obtained from the belt-shaped body is given by the following expression (IV):

K=X+2N

Where X is 1.5 or 2; and

N is the number of windings of the belt-shaped body except the top face and bottom face of the article-accommodating body

Here, the X is a value for determining an appearance of the article-accommodating body and if this value is 1.5, a regular triangular pyramid accommodating body can be obtained. If the value is 2, a clear corner configuration or a narrow bottomed cylindrical shape of the accommodating body is obtained. The triangular pyramid accommodating body possesses a function as a small article container if it is of small size and if it is of large size, it can be used as a shopping bag or the like. The rectangular accommodating body is available as a purse, a tobacco case, a camera case, a document case or the like depending on its size. If it is of a narrow cylindrical shape, it can be used as a mobile phone case or glasses case.

The aforementioned value N determines the height of the accommodating body in connection with the tape width W of the tape main body and the dimension a′ from the center of the first engaging position of the coupling elements up to the end face in the length direction of the tape main body near the position. This value is twice of the actual winding number excluding the top face and bottom face of the accommodating body. Therefore, although this value N may be determined arbitrarily, it is preferred to be at least one or more.

Preferably, the contraction coefficient α of the tape main body when the coupling elements are mounted is in a range of 0 to 6.0%. As for attachment of these coupling elements to the tape main body, the coupling elements may be attached integrally to the periphery of the tape main body by molding or crimping, or the coupling elements may be attached integrally to a side edge of a long tape strip by molding or crimping and then the narrow tape strip may be sewed to the periphery of the tape main body with the coupling elements arranged outside. Although upon attachment of the coupling elements by molding, some extent of contraction should be estimated in either case of the tape strip or tape main body, little contraction occurs in the attachment by crimping. Further, in the case of a tape strip being attached to the tape main body, it may be attached with adhesive agent or by fusion by means of ultrasonic or high-frequency pressure heating means. In this case, no contraction is generated and these methods may be used with sewing.

Although the contraction coefficient a of the tape main body of the present invention includes a case where it is 0%, usually, the coupling elements are mounted on a narrow tape strip of a predetermined length preliminarily and the tape strip is sewed to the periphery of the tape main body. In this case, contraction occurs in the tape main body due to the sewing. Because the contraction coefficient α varied depending on the material and the structure of the tape main body, which may be made of fiber knitted/woven tape, synthetic resin tape, synthetic leather tape, natural leather tape or the like, the inventors tried confirming that value through trial tests. Consequently, its upper limit value was found to be 6%. The contraction coefficient α of the tape main body is a value when a tape strip containing the coupling elements is sewed to the tape main body and preferably, the contraction coefficient α is in a range of 0.2 to 6.0%.

It has been found that the contraction coefficient a of the tape main body due to sewing varies depending on the material, structure of the tape main body and the tape width. For the reason, tape main bodies of various materials, structures and tape widths were prepared and tape strips provided with the coupling elements were fixed to the tape main bodies by sewing. Then, contraction coefficients of these were obtained. Consequently, in the case of mesh-like tape fabric, the contraction coefficient a was in a range of 0.2 to 1.2% although it varies depending on the tape width and mesh (percentage of void). The contraction coefficient a was in a range of 0.3 to 0.5% in the case of synthetic leather or natural leather and in the case of an ordinary woven tape, the value is as large as 1.0 to 5%.

The correction value β is preferred to be in a range of 1.01 to 1.20. Depending on the structure and configuration of the tape main body, particularly if the tape main body has a dense structure or rough structure, for example, in the cases of an ordinary woven tape and a mesh woven tape, various influences are generated after the coupling elements are mounted to the tape main body, besides the above-described contraction coefficient. In the case of for example, a rectangular accommodating body, as it is close to a narrow cylinder shape, that value becomes larger. The correction value β is a value for eliminating this influence and may be selected appropriately depending that configuration.

Preferably, the interval V between the opposing side edges of the tape main body when the coupling elements are engaged is in a range of 5 mm or more to 20 mm or less. This value V is a value which affects the vertex position of the article-accommodating body to be obtained. If that value is out of the range, the vertex position gets deflected or the shape becomes twisted. Considering the vertex position and a sliding resistance of the slider, a further preferred value is in a range of 9 to 13 mm.

The coupling elements, which are to be mounted on the periphery of the belt-shaped body of the present invention, are mounted continuously at an equal pitch along the entire periphery of the tape main body if the coupling element is a snap button. If a narrow tape strip on which the coupling elements are previously mounted continuously is sewed to the tape main body, there should be a region in which linkage members such as a releasable bottom end stop are respectively attached at positions apart in predetermined length from ends of the tape main body in order to link with each other so that no coupling elements exist.

The above-described value T is an interval between end faces of the linkage members at the first engaging position in which no coupling elements exist. Usually this value hardly affects the configuration of the article-accommodating body. However, if this value is too large, an opening is formed in the bottom portion of the accommodating body so that the appearance of the accommodating body is deteriorated and there occurs a problem in functional viewpoints. On the other hand, its lower limit value is large enough to link the linkage members with each other. As the linkage members other than the releasable bottom end stop, if for example, the engaging element is a snap button, a pair of the snap buttons adjacent each other act as the linkage members.

Further, preferably, the constants D, E, which are values of ratios of the length L₁ of the tape portion of the top/bottom faces of the accommodating body and of the length L₂ which is ½ the winding number 1 (N=1) of a tape portion at an intermediate portion thereof with respect to a lateral length a of the accommodating body flattened, are in a range of 1.00 to 1.20 (=D) and 1.07 to 1.50 (=E).

According to the present invention, a narrow extension member may be extended from part of the periphery of the tape main body. In this case, when the accommodating body is produced from the belt-shaped body, the narrow extension member can be used as a handle strap. Thus, preferably, one engaging/disengaging member is provided at a front end of the extension member while the other engaging/disengaging member which engages or disengages said one engaging/disengaging member is mounted at a desired position of the tape main body and/or the extension member. Further, if the front and rear faces of the tape main body are respectively processed in different patterns or colors, both the front and rear surfaces can be used by being turned over. At this time, the front and rear surfaces of the narrow tape are also preferred to be processed in different patterns or colors.

### BRIEF DESCRIPTION OF THE DRAWINGS

FIG. 1 is a plan view of a belt-shaped body of the present invention;

FIG. 2 is a front view of a rectangular case-like accommodating body according to a typical embodiment of the present invention;

FIG. 3 is a front view when engagement of coupling elements on a top face portion of the accommodating body is released;

FIG. 4 is a bottom view of the accommodating body;

FIG. 5 is a front view of a regular triangular pyramid shaped accommodating body obtained from the belt-shaped body of the present invention;

FIG. 6 is a solid diagram showing a condition in which a portion corresponding to a top face of the same accommodating body is opened;

FIG. 7 is a front view when the accommodating body is flattened by pressing the central portion of the accommodating body at end stops of the accommodating body.

FIG. 8 is a solid view showing a use condition of a rectangular accommodating body obtained according to the present invention;

FIG. 9 is a solid view of the triangular pyramid accommodating body;

FIG. 10 is a plan view of a belt-shaped body according to another embodiment of the present invention;

FIG. 11 is a rear view of an extension-member side of the belt-shaped body;

FIG. 12 is a plan view of an extension-member side of a belt-shaped body according to a modified example of the embodiment;

FIG. 13 is a perspective view showing an entire structure of an accommodating body produced from the belt-shaped body;

FIG. 14 is a partial perspective view when the accommodating body is viewed from an opposite side;

FIG. 15 is an explanatory view showing a use condition of the extension member of the accommodating body;

FIG. 16 is a perspective view showing an example of the structure of a length adjusting member disposed on a free end side of the extension member;

FIG. 17 is a partial perspective view showing another modified example of the embodiment;

FIG. 18 is an entire perspective view of an accommodating body having another structure according to still another embodiment of the present invention;

FIG. 19 is an entire perspective view of an accommodating body according to a modified example of the embodiment;

FIG. 20 is a perspective view showing one of the use conditions thereof;

FIG. 21 is a plan view of a belt-shaped body according to still another embodiment of the present invention;

FIG. 22 is a partial plan view showing a modified example of the embodiment;

FIG. 23 is a partial perspective view showing an accommodating body produced from the belt-shaped body of the above embodiment;

FIG. 24 is a plan view showing another embodiment of the belt-shaped body of the present invention;

FIG. 25 is a plan view schematically showing a structure of an extension member of the belt-shaped body;

FIG. 26 is a partial plan view showing a condition in which engagement of coupling elements of a coupling element linking member which is a component of the extension member is released;

FIG. 27 is a partial plan view of an extended end portion of the extension member according to a modified example of the embodiment;

FIG. 28 is a partial plan view of a tape main body and an extension member according to another modified example of the same embodiment;

FIG. 29 is a perspective view showing an entire configuration of an accommodating body produced from the belt-shaped body of the embodiment;

FIG. 30 is an entire perspective view showing a modified example of the accommodating body;

FIG. 31 is an explanatory diagram showing a use condition of the accommodating body produced from the belt-shaped body of the embodiment;

FIG. 32 is a plan view of a belt-shaped body according to another modified example of the embodiment;

FIG. 33 is a perspective view showing a configuration and a use condition of the accommodating body produced from the belt-shaped body;

FIG. 34 is a top view of a belt-shaped body according to still another embodiment of the present invention while representation of part thereof is omitted;

FIG. 35 is a rear view of the belt-shaped body;

FIG. 36 is a partial sectional view of an example of coupling elements fixed to the belt-shaped body at the time of engagement;

FIG. 37 is a partial sectional view of another example;

FIG. 38 is a partial sectional view of still another example;

FIG. 39 is a side view showing an example of a structure of the slider shown in FIG. 36;

FIG. 40 is a perspective view showing an example of a structure of the slider shown in FIG. 37;

FIG. 41 is a side view for explaining movement of a pull of the slider;

FIG. 42 is a side view of the accommodating body obtained from the belt-shaped body of the embodiment;

FIG. 43 is a side view of the accommodating body obtained by exposing a rear face of the belt-shaped body;

FIG. 44 is a top view of a belt-shaped body according to still another embodiment of the present invention while representation of part thereof is omitted;

FIG. 45 is a partial rear view showing an example of the structure of an end portion on the side in which the extension member is provided;

FIG. 46 is an entire perspective view of the accommodating body obtained by exposing a top face of the belt-shaped body;

FIG. 47 is an entire perspective view of the accommodating body obtained by exposing a rear face of the belt-shaped body;

FIG. 48 is a top view of a belt-shaped body according to still another embodiment of the present invention while representation of part thereof is omitted;

FIG. 49 is a partial sectional view showing a structure when the extension member of the accommodating body obtained by exposing the rear face of the belt-shaped body is exposed;

FIG. 50 is a partial perspective view of the accommodating body;

FIG. 51 is a top view of a belt-shaped body according to still another embodiment of the present invention while representation of part thereof is omitted;

FIG. 52 is a rear view of an extended side end portion of an extension member of the belt-shaped body;

FIG. 53 is a partial perspective view showing part of the accommodating body obtained according to the embodiment; and

FIG. 54 is a top view of a belt-shaped body according to still another embodiment of the present invention while representation of part thereof is omitted.

### DESCRIPTION OF THE EMBODIMENTS

Hereinafter, the embodiments of the present invention will be described in detail with reference to the accompanying drawings.

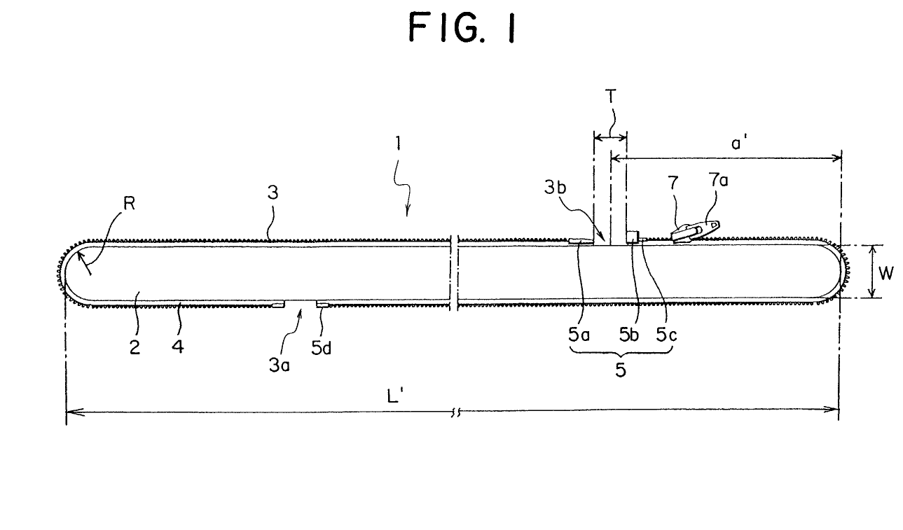

FIG. 1 is a front view of a belt-shaped body showing an embodiment having a basic structure of the present invention.

In the belt-shaped body 1 of the embodiment shown in FIG. 1, a plurality of coupling elements 3 are disposed continuously along an outer periphery of a tape main body 2 thereof having a predetermined length and width. As the tape main body 2, for example, various kinds of fiber-made tape woven/knitted fabric, various kinds of tape-like non-woven fabric, synthetic resin tape, natural leather tape, synthetic leather tape and the like can be applied. These can be selected depending on application. For smooth engagement/disengagement of the coupling elements 3, both end portions in the longitudinal direction of the tape main body 2 are preferred to be formed in arc shapes.

Each of the coupling elements 3 shown in FIG. 1 has the same structure as a generally known slide fastener coupling element, which is comprised of a leg portion to be fixed to a side edge portion of the slide fastener tape and a coupling head which engages a mating coupling element 3. This coupling element 3 may be of metal or synthetic resin. The synthetic-resin-made coupling element may be an independent type in which individual coupling elements 3 are independent like ordinary metallic coupling elements, or a continuous type such as coiled elements made by forming synthetic resin monofilament into a coil shape such that their coupling heads are formed on part of each coiled portion and arranged in line and zigzag elements made by bending synthetic resin monofilament successively to form a zigzag shape such that their coupling heads are formed on the bent end portions.

Meanwhile, the coupling element of the present invention should not be restricted to such coupling elements to be used in the above-described slide fastener, but it is permissible to use a snap coupling device such as a well-known snap button which is adapted to be snap fit by pressing or insertion, as disclosed in, for example, the above-mentioned U.S. patent specification. Further, it is also permissible to employ a surface fastener which is comprised of a plurality of coupling elements and which is to be engaged with a mating fastener via a plane by pressing. In the former snap coupling device, male and female engaging/disengaging members are attached on the periphery of the tape main body 2 in succession continuously so as to correspond to a plurality of the respective engaging positions of the snap coupling device.

The coupling elements 3 of this embodiment are made of synthetic resin independently and like an ordinary slide fastener stringer, are mounted integrally along a side edge of a narrow tape strip 4 corresponding to a fastener tape at a predetermined pitch by molding. Then, the tape strip 4 in which a plurality of the coupling elements 3 are mounted continuously on the side edge is sewed along the entire periphery of the tape main body 2.

According to this embodiment, a linking member 5 having the same structure as that of a releasable bottom end stop, which is generally known as a kind of an end stop for a slide fastener, is fixed at a coupling-element-mounting position, which is inward from an end of the belt-shaped body 1 obtained in the above-described manner in a length a′ which is set preliminarily in the longitudinal direction. Then, a pair of end stops 5d, which have the same structure as a top end stop of a slide fastener, are attached with a predetermined interval on a diagonal line of the fixing position of the aforementioned linking member 5 on the other side edge of the belt-shaped body 1. Therefore, the coupling elements 3 which were supposed to be mounted at mounting positions of the linking member 5 and the end stops 5d are not previously mounted or removed from the positions. Consequently, in which the linking member 5 and the end stop 5d are to be mounted, so that separating portions 3a, 3b are formed.

The linking member 5 comprises an insert pin 5a and a box pin 5c fixed to a box 5b, which are mounted on a mounting position of the releasable bottom end stop such that they oppose each other, like a well-known structure of a slide fastener provided with a releasable bottom end stop which is usually mounted on an ordinary jumper and the like. A slider 7 is attached to the coupling elements 3, 3, at the side of the box pin so as to be freely slidable. The end stop 5d is fixed at its mounting position where coupling elements are removed, adjacent to the coupling elements 3 located at separated end portions thereof.

Here, the length of the belt-shaped body 1 and the mounting positions of the linking member 5 and the end stops 5d are determined depending on the shape and the dimension of each of the accommodating bodies 30, 31, each of which is obtained by winding the belt-shaped body 1 spirally while coupling the aforementioned coupling elements successively. The length of the belt-shaped body 1 and the shape of the accommodating body are determined by an actual length L′ of the tape main body 2 which is their major component and expressions (I), (II), (III) containing several other factors, which will be described below.

In an example shown below, the actual length L′ necessary for the tape main body 2 is obtained by substituting a concrete value into the aforementioned expression (II) and (III).

### EXAMPLE 1

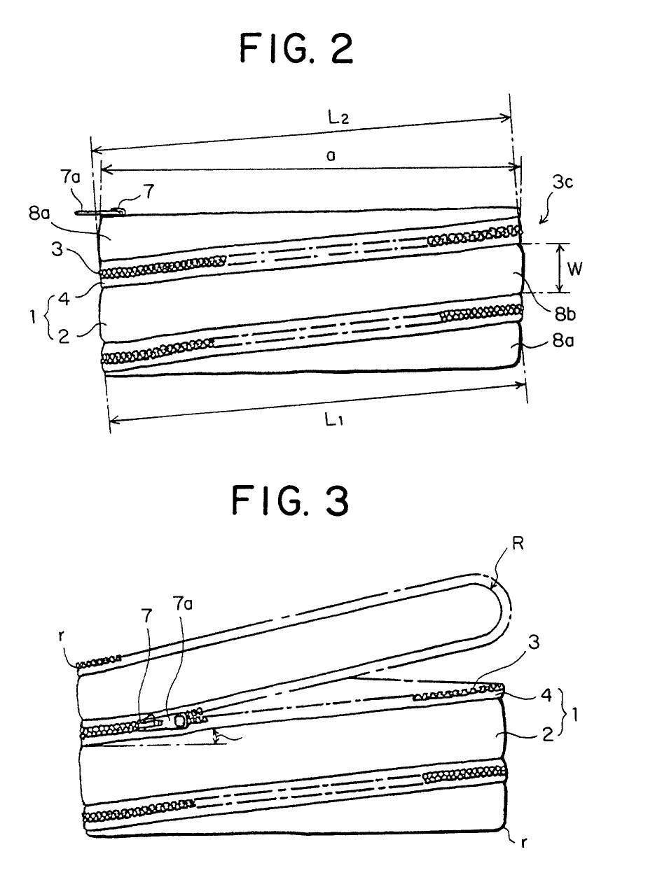

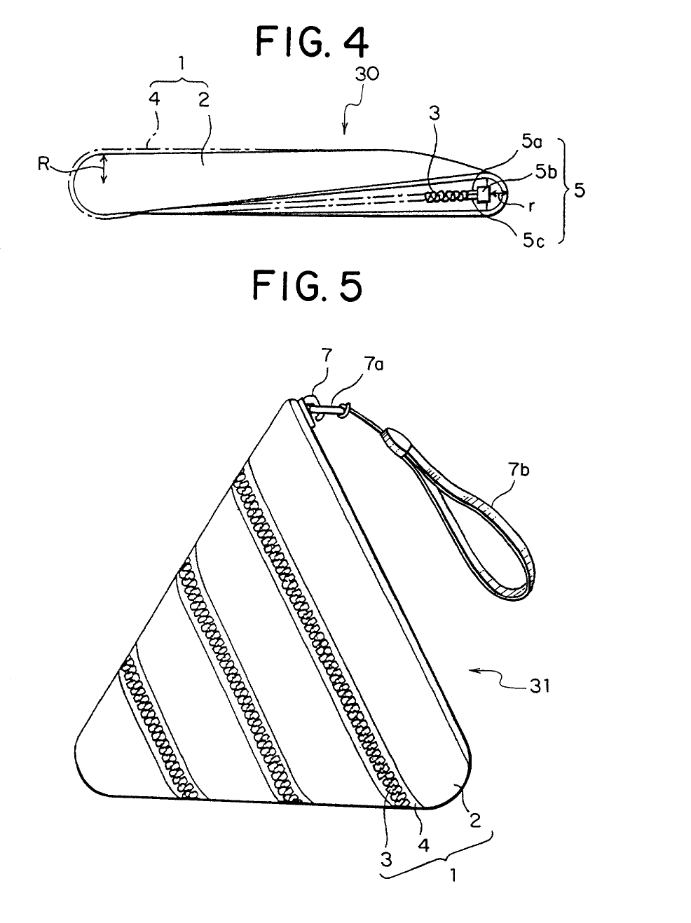

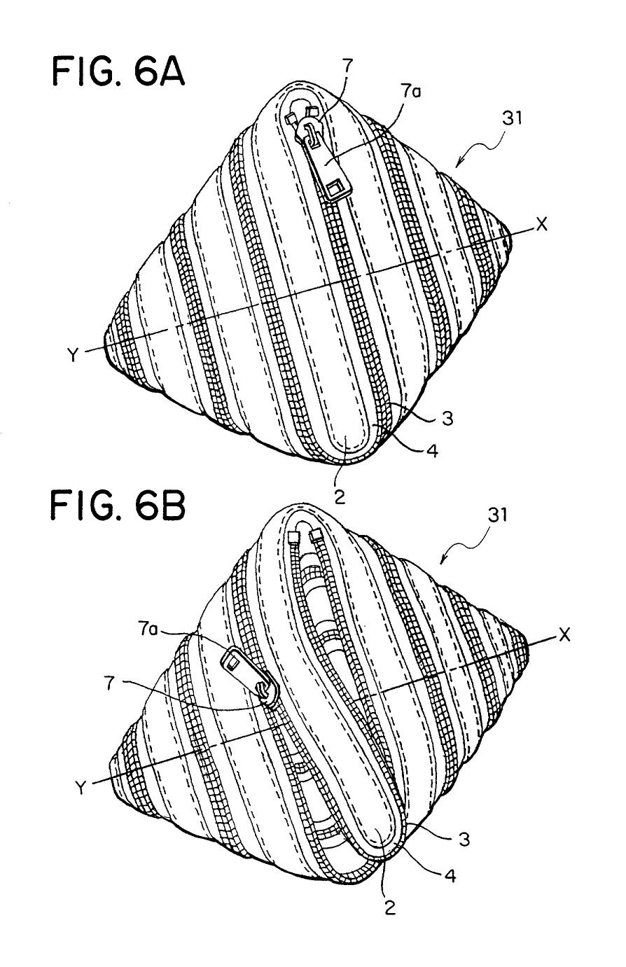

Assuming that a=100 mm, W=20 mm, T=18 mm, X=2, N=1.5, and contraction coefficient α of the tape main body 2 when the tape strip 4 is sewed by means of a differential feeding sewing machine is 1%, a theoretical length L and an actual length L′ of the tape main body 2 necessary for obtaining the rectangular case shaped accommodating body 30 shown in FIGS. 2 and 3 are found.

$$\begin{matrix}θ = {tan}^{- 1} ( W / a ) = {tan}^{- 1} ( 20 / 100 ) = {11.309}^{ °} \\ {L}_{1} = a / cos θ - T / π + T / 2 \\ = 100 / cos 11.309 - 20 / 2 - 18 / π + 18 / 2 \\ = 105.25 mm \\ {L}_{2} = a / cos θ - W / 2 - T / π + π W / 4 + T / 2 \\ = 100 / cos 11.309 - 20 / 2 - 18 / π + 20 π / 4 + 18 / 2 \\ = 110.96 mm \\ 2 {L}_{1} + 2 \times 1.5 \times {L}_{2} \\ = 2 \times 105.25 + 3 \times 110.96 \\ = 210.50 + 332.88 = 543.38 mm \\ {L}^{′} = L ( 1 + α / 100 ) = ( 2 {L}_{1} + 2 \times 1.5 \times {L}_{2} ) \cdot ( 1 + α / 100 ) \\ = ( 2 \times 105.25 + 3 \times 110.96 ) \times ( 1 + 0.01 ) \\ = 548.8 mm\end{matrix}$$

Although the theoretical length is 543.38 mm, a tape cut length L′ actually required when contraction due to sewing considered is 548.8 mm.

### EXAMPLE 2

In the expressions (II) and (III), the actual length L′ of the tape main body 2 necessary for obtaining the regular triangular pyramid accommodating body 31 shown in FIG. 5 is found. Here, it is assumed that a lateral length a′ when tape portions corresponding to a top face and a bottom face are unfolded is equal to the length L₁. In this example, even if this assumption is made, no special defect is generated in practice because the contraction due to the sewing will be considered later. T is a dimension necessary for engaging or disengaging the linking member 5. In this example, this is set to be T=18 mm. If this value of T is in a range of 17-19 mm, no special change in the shape of the accommodating body 31 is generated.

For the tape cut length L′, the following expression is used.

L′=L(1+α/100)=(XL₁+2NL₂)·(1+α/100)

Here, it is set that a=173 mm, W=30 mm, T=18 mm, X=3/2, N=3 and α=1%.

$$\begin{matrix}θ = {tan}^{- 1} ( W / a ) = {tan}^{- 1} ( 30 / 173 ) = {9.837}^{ °} \\ {L}_{1} = a / cos θ - r + T / 2 \\ = 173 / cos {9.837}^{ °} - 18 / π + 9 \\ = 178.85 mm \\ {L}_{2} = a / cos θ - W / 2 - T / π + π W / 4 + T / 2 \\ = 173 / cos {9.837}^{ °} - 30 / 2 - 18 / π + 30 π / 4 + 9 \\ = 187.41 mm \\ L = 3 {L}_{1} / 2 + 2 \times 3 \times {L}_{2} \\ = 3 \times 178.85 / 2 + 6 \times 187.41 \\ = 268.275 + 1124.46 = 1392.76 mm \\ {L}^{′} = L ( 1 + α / 100 ) = ( 3 {L}_{1} / 2 + 2 \times 3 \times {L}_{2} ) \cdot ( 1 + α / 100 ) \\ = ( 3 \times 178.85 / 2 + 6 \times 187.41 ) \times ( 1 + 0.01 ) \\ = 1406.68 mm\end{matrix}$$

While the theoretical cut length of the tape main body 2 is 1392.74 mm, the tape cut length L′ considering the contraction due to the sewing is 1406.68 mm. Additionally, for the length a′ when portions composing the top face and the bottom face are unfolded, it is necessary to take the contraction coefficient α into account. However, with this only, a stabilized configuration of the accommodating body 31 in terms of appearance cannot always be obtained when the accommodating body 31 is formed. Here, the dimension of a′ is important and unless a′ is an appropriate value, the vertexes of the accommodating body is deflected laterally.

### EXAMPLE 3

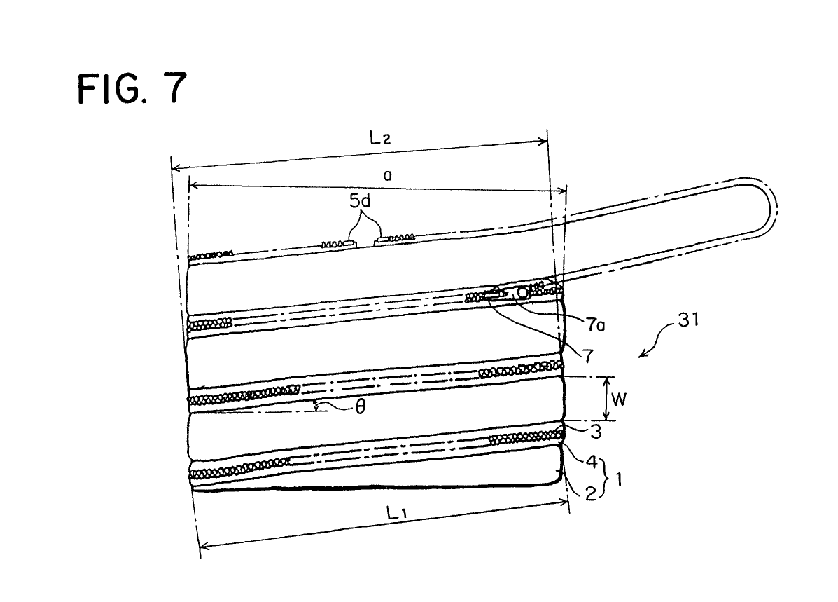

A test with respect to a dimensional difference when a tape strip 4 having the engaging elements 3 was sewed onto a tape main body 2 was made. That is, when the tape strip 4 made of the same material and having the same structure was 1400 mm, the actual cut length L′ of the tape main body 2 was divided into three groups: (i) 1406 mm, (ii) 1410 mm, (iii) 1420 mm. Then, Table 1 shows a finishing dimension of the corresponding belt-shaped body 1 that was obtained when the length a′ actually necessary as shown in FIG. 7 was set to be 177 mm, 180 mm and 185 mm by changing a correction value β(=a′/a) of each group. Further, the Table evaluates the lateral deflection of the vertexes of each of nine regular triangular pyramid accommodating bodies formed from the respective belt-shaped bodies 1.

In the Table, “⊚” indicates a case where the vertexes are located substantially in the center, “◯” indicates a case where there is a deflection allowable in actual use, “Δ” indicates a case where the deflection is less allowable, and “X” indicates a case where the vertex is so deflected to the right or the left that it is hard to be use for actual purpose. The “right” and “left” indicate the deflecting directions.

The sewing condition of the tape strip 4 onto the tape main body 2 is as follows.

Sewing machine type: differential feeding sewing machine

Feeding adjustment: graduation 8

Needle: #14

Yarn: #30

Pitch: graduation 3

TABLE 1

| | Cut | a′ | Finishing | | |
|---|---|---|---|---|---|
| | length | dimension | dimension | Deflection | |
| No. | (mm) | (mm) | (mm) | evaluation | |
| 1-1 | 1406 | 177 | 1380 | X left | (1-1): if the |
| 1-2 | | 180 | 1382 | ⊚ | tape was |
| 1-3 | | 185 | 1382 | X right | shorter than |
| | | | | | this, the |
| | | | | | fastener |
| | | | | | would be left |
| | | | | | over. |
| | | | | | (1-3): it is |
| | | | | | slightly |
| | | | | | puckered. |
| 2-1 | 1410 | 177 | 1382 | Δ left | |
| 2-2 | | 180 | 1382 | ◯ | |
| 2-3 | | 185 | 1384 | X right | |
| 3-1 | 1420 | 177 | 1386 | X left | (3-2): when |
| 3-2 | | 180 | 1390 | ⊚ | it is sewed |
| 3-3 | | 185 | 1392 | X right | along to a |
| | | | | | dimension of |
| | | | | | the fastener, |
| | | | | | it is |
| | | | | | possible to |
| | | | | | adjust the |
| | | | | | tape length |
| | | | | | during the |
| | | | | | sewing |
| | | | | | without being |
| | | | | | puckered. |

As is understood from the above Table 1, unless the contraction coefficient a due to the sewing and the correction value β are determined properly, the vertexes of the obtained regular triangular pyramid accommodating body are deflected in the lateral direction, so that the accommodating body is difficult to be reduced into practice.

### EXAMPLE 4

Next, influences of differences of the material and the structure of the belt-shaped body 1 and the tape main body 2 at the time of sewing was tested using (A) mesh woven tape main body, (B) synthetic leather tape main body and (C) ordinary woven tape main body. Meanwhile, in the mesh woven tape main body used here, its central portion in the width direction was formed of a mesh structure and both side edge portions thereof had a fine structure in order to stabilize the sewing. As described above, the influences at the time of sewing depend on the theoretical lateral dimension a, actually formed lateral dimension a′ and the directly related contraction coefficient α and the correction value β.

As for the length of the tape strip 4 having the coupling elements 3 secured thereto, two pieces of the tape strip 4, which are 1360 mm long, are used for all the tapes (A) to (C) in common.

(1) Mesh woven tape (A)

The sewing condition of the tape main body 2 having the coupling elements onto the tape main body 2 is as follows.

Needle for use: #11, yarn: #50, pitch: graduation 3, sewing machine for use: 1-needle lock stitch sewing machine

Respective dimensional conditions are as follows.

a=165.5 mm, W=32 mm, V=7 mm, T=18 mm, X=3/2, N=3

Under such dimensional conditions, winding gradient θ of the tape main body 2, the theoretical length L₁ of the upper face/bottom face, the theoretical length L₂ of an intermediate portion and the theoretical entire length L of the tape main body 2 were calculated according to the expressions (II)-(IV), and then the contraction coefficient at the time of sewing was introduced by comparing with the theoretical entire length L′ of the actually necessary tape main body 2.

$$\begin{matrix}θ = {tan}^{- 1} ( W / a ) = {tan}^{- 1} ( 32 / 165.5 ) = {10.943}^{ °} \\ {L}_{1} = a / cos θ - T / π + T / 2 \\ = 165.5 / cos {10.943}^{ °} - 18 / π + 18 / 2 \\ = 171.835 mm \\ {L}_{2} = a / cos θ - W / 2 - T / π + π W / 4 + T / 2 \\ = 165.5 / cos {10.943}^{ °} - 32 / 2 - 18 / π + 32 π / 4 + 18 / 2 \\ = 180.968 mm \\ L = 3 {L}_{1} / 2 + 6 {L}_{2} \\ = 3 \times 171.835 / 2 + 6 \times 180.968 \\ = 1343.564 mm\end{matrix}$$

Here, the contraction coefficient a was set to be 0.22% considering the contraction due to the sewing and the actual cut length L′ was obtained as follows.

$$\begin{matrix}{L}^{′} = L ( 1 + α / 100 ) \\ = 1343.564 \times 1.0022 \\ = 1346.52 mm\end{matrix}$$

An accommodating body 31 was formed using a belt-shaped body 1 obtained by sewing the aforementioned tape strip 4 having the coupling elements for the tape main body 2 having such a length. Consequently, a stabilized regular triangular pyramid accommodating body 31 was obtained. However, the actual lateral dimension a′ shown in FIG. 7 was 171 mm.

Therefore, the correction value β of this case was:

β=a′/a=171÷165.5=1.03

Therefore, when the lateral dimension a′ necessary for the actual accommodating body 31 is determined, correction with the aforementioned correction value β is necessary. Unless the design lateral dimension a is corrected with the correction value β in order to obtain the lateral dimension a′, the deflection of the vertex position cannot be corrected.

(2) Synthetic leather tape main body (B)

The sewing condition of the sewing machine was that a total feeding sewing machine was used with needle: #21, yarn: #8, pitch: graduation 3.

The dimensional condition was a=167, W=30, V=12, T=18, X=3/2, N=6, and the contraction coefficient α=0.37%.

θ=tan⁻¹(W/a)=tan⁻(30/167)=10.184°

$$\begin{matrix}{L}_{1} = a / cos θ - T / π + T / 2 \\ = 167 / cos {10.184}^{ °} - 18 / π + 18 / 2 \\ = 172.943 mm \\ {L}_{2} = a / cos θ - W / 2 - T / π + π W / 4 + T / 2 \\ = 167 / cos {10.184}^{ °} - 30 / 2 - 18 / π + 30 π / 4 + 18 / 2 \\ = 181.505 mm \\ L = 3 {L}_{1} / 2 + 6 {L}_{2} \\ = 3 \times 172.643 / 2 + 6 \times 181.505 \\ = 1348 mm \\ {L}^{′} = L ( 1 + α / 100 ) = 1348 \times 1.0037 = 1353 mm\end{matrix}$$

In the case of the synthetic leather tape main body (B), the actual lateral dimension a′ shown in FIG. 7 is not equal to the length L₁ of the top/bottom face. Therefore, β is considered as the correction value. The value a′ needs to be obtained through a test by sewing.

Because a′=169 in this example 4, the correction value β is 169/167=1.012.

(3) Ordinary fabric tape main body (C)

The sewing condition of the sewing machine was feeding adjustment: graduation 8, needle: #14, yarn: #30, pitch: graduation 3.

The dimensional condition was that the tape width W was 30 mm, the theoretical lateral dimension a shown in FIG. 7 was 168 mm, a sewing width V between the tape main body 2 and the tape strip 4 was 12 mm and the contraction coefficient α was 2%. Further, the theoretical length L₁ of the upper/bottom face was assumed to be equal to the actual lateral dimension a′ shown in FIG. 7. The correction value β of the case where the ordinary tape main body (C) was used was assumed to be 1.04.

Under these conditions, the theoretical length L₁ of the upper/bottom face and the length L₂ of the intermediate portion were obtained according to the expressions (II)-(IV) and then, a theoretical finishing tape length L was obtained. Consequently, the length L was 1350 mm and the finishing tape length actually necessary considering the contraction coefficient α was 1380 mm. The actual lateral dimension a′ obtained using the finished belt-shaped body 1 shown in FIG. 7 was 174 mm and this configuration was stabilized while the vertex of its regular triangular pyramid was located in the center.

If it is intended to provide the accommodating body with design performance or fashion performance, the coupling elements with tape to be mounted on the outer periphery of the belt-shaped body 1 is colored in a different color than the tape main body 2 so as to make its spiral pattern outstanding. Alternatively, a diversified pattern may be printed on the tape main body 2. If it is intended to express himself or herself, two pieces of the tape main bodies 2 without any pattern are prepared and then, his or her initial letter, photograph, logo mark or the like may be printed on the surface of the tape main body 2. Such a print can be executed promptly by, for example, an ink jet printer or thermal transfer.

If the aforementioned accommodating body 30, 31 is restored to the original belt-shaped body 1, the slider 7 is slid in an opposite direction to be engaged with the linking member 5. If the insert pin 5a is removed from the slider 7 and the box 5b, an end portion of the folded back belt-shaped body 1 is restored to the original state so that it becomes a straight belt-shaped body 1. According to the present invention, it is permissible to mount the male/female engaging members on both the end portions of such a straight belt-shaped body 1. It can be used in other diversified applications besides the accommodating bodies 30, 31 as described above, which will be described later.

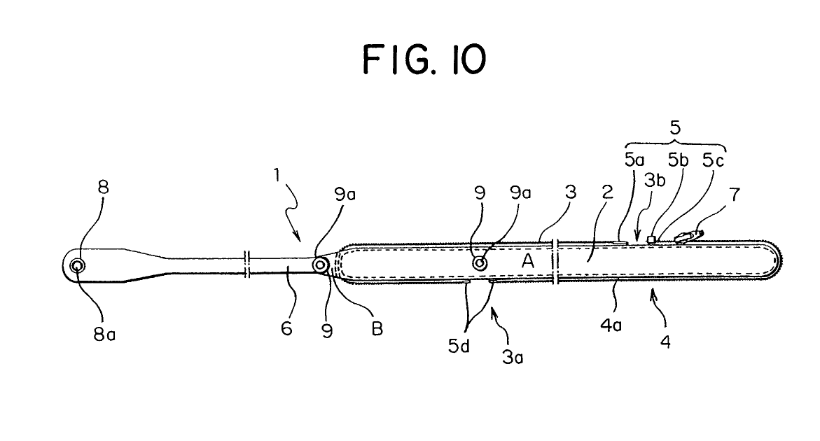

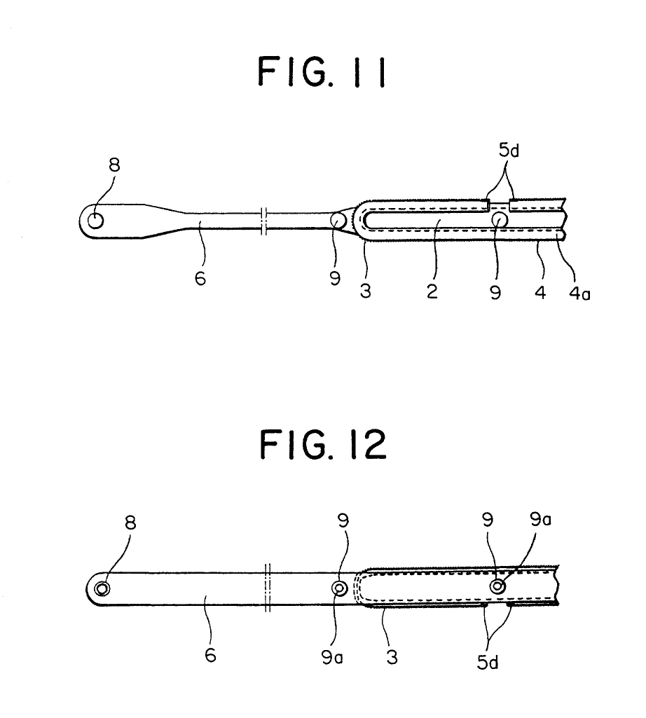

According to the present invention, it is permissible to extend an extension member 6 from part of the periphery of the tape main body 2. FIGS. 10 and 11 show the structures of front and rear faces of a tape-like article of another embodiment of the present invention. The tape-like article of this embodiment is a long belt-shaped body 1, comprising a tape main body 2 which is a sheet main body of which one end in the longitudinal direction is formed in an arc shape and a tape strip 6 which is an extension member extended from the other end of the tape main body 2. Although according to this embodiment, the tape main body 2 and the tape strip 6 are manufactured integrally and continuously using a single tape material, this embodiment should not be restricted to this and it is permissible to join the tape main body 2 and the tape strip 6 manufactured separately, to connect the tape strip 6 to the other end of the tape main body 2 by sewing or fusion.

The width of the tape strip 6 of this embodiment is smaller than that of the tape main body 2 except the front end thereof. Further, as shown in FIG. 12, the widths of the tape main body 2 and the extension member 6 may be the same. Because according to this embodiment, the tape main body 2 and the tape strip 6 are formed consecutively in the longitudinal direction as described above, the coupling elements 3 attached to the substantially entire periphery of the tape main body 2 in order to form an accommodating body are attached in an annular shape to the periphery of a rear face of a region of the tape main body 2 of the belt-shaped body 1 except two separating portions 3a, 3b excluding coupling elements 3. The aforementioned separating portions 3a, 3b are formed at symmetrical positions on the periphery of each of opposing sides inward by a predetermined dimension from both ends in the longitudinal direction of the tape main body 2.

The coupling elements 3 are formed of coupling elements to be applied for an ordinary slide fastener. The tape main body 2 is attached with a tape portion 4a of a fastener stringer, in which a plurality of the coupling elements 3 are fixed on a side edge of the fastener tape of the slide fastener at equal pitches, by sewing. A slider 7 is mounted slidably on the aforementioned coupling elements 3 in order to engage or disengage the coupling elements 3 disposed at equal pitches. As for the two separating portions 3a, 3b, a slider stopper device 5d, which corresponds to a top end stop of an ordinary slide fastener, is fixed integrally to the coupling element 3 disposed at one separating portion 3a. A linking member 5 comprised of a box pin 5c, a box 5b and an insert pin 5a, which corresponds to a releasable bottom end stop of the slide fastener, is fixed integrally with the coupling elements 3 disposed so as to be opposed to each other at the other separating portion 3b.

The tape strip 6, which is the aforementioned extension member, is extended directly from the other end of the tape main body 2 as described above, and a female engaging portion 8a, which is a female snap button 8 as a female engaging device, is fixed on the surface at its front end such that it is exposed thereon. According to this embodiment, a male snap button 9, which is a male engaging device, is fixed on the surface of a border region B between the tape strip 6 and the tape main body 2 such that it is exposed thereon. Further, a male snap button 9, which is a male engaging device, is fixed at a portion adjacent the separating portion 3a of the tape main body 2 on which the slider 5d is mounted, such that its male engaging portion 9a is protruded thereon.

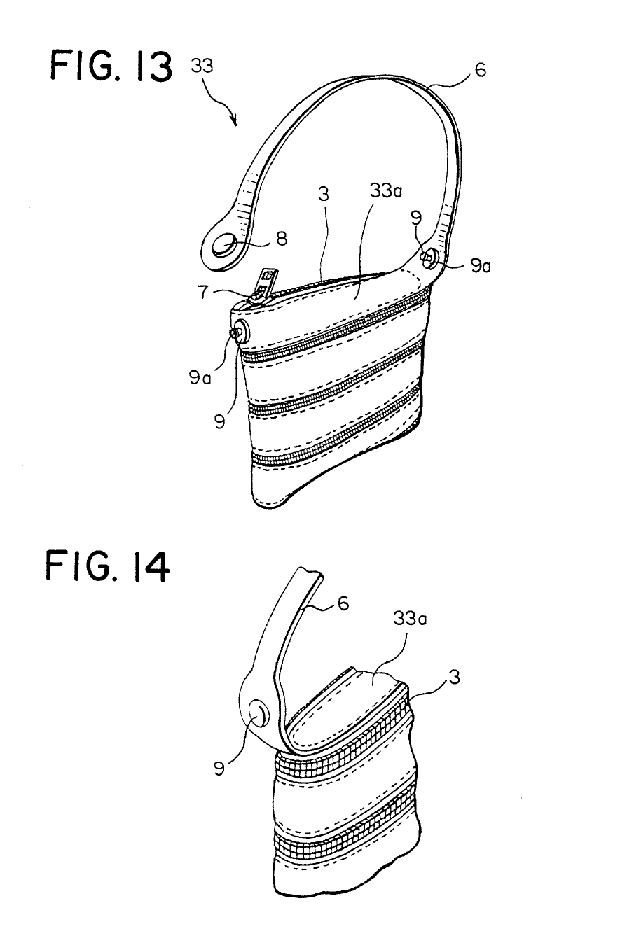

FIGS. 13 and 14 show an example of the accommodating body formed of the belt-shaped body 1 having the above-described structure. FIG. 13 is an entire perspective view of its lid portion 33a as viewed from an end thereof, and FIG. 14 is a partial perspective view of the same lid portion as viewed from the other end thereof. In the aforementioned accommodating body 33, the box pin 5c of the linking member 5 fixed on one separating portion 3b is inserted into the slider 7 while the insert pin 5a is inserted into the box 5b through the slider 7, and then the box pin 5c is linked with the insert pin 5a. After that, by winding the belt-shaped body 1 spirally around the linking member 5, the slider is slid so as to join the corresponding coupling elements 3.

In the indicated example, the accommodating body has a flat thin rectangular box shape and the aforementioned snap button 9 is disposed on one end portion of its upper lid portion 33a and the other male snap button 9 is disposed at an extended end portion of the tape strip 6. The female snap button 8 is disposed at a front end portion of the tape strip 6 extended directly from the lid portion 33a of the accommodating body 33.

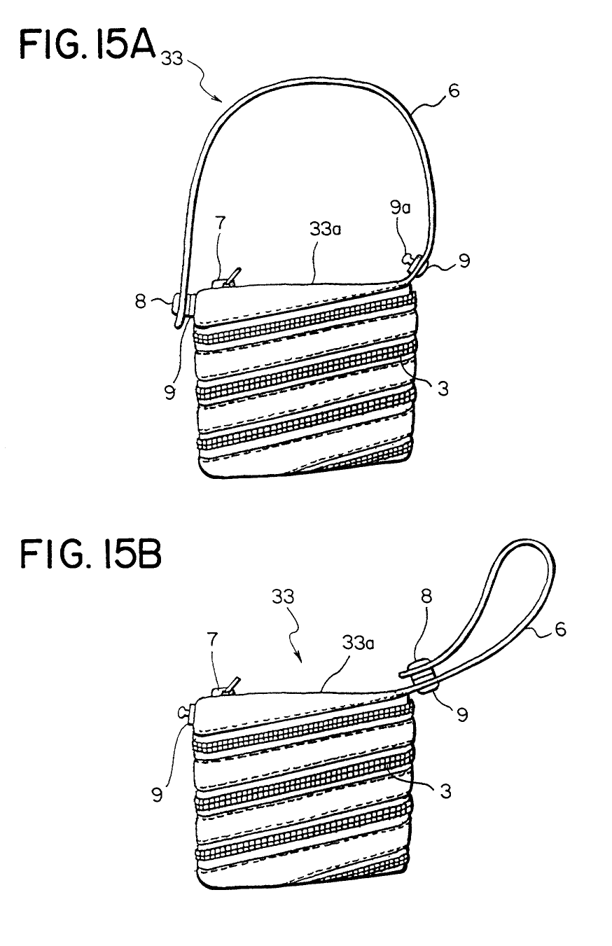

FIGS. 15A and 15 B show two use examples of a case where the tape strip 6 is used as a handle strap. That is, the female snap button 8 fixed on a front end of the tape strip 6 is engaged with the male snap button 9 disposed at an end of the lid portion 33a. Consequently, as shown in FIG. 15A, the tape strip 6 is laid across the rectangular box shaped lid portion 33a so that it can be used as a handle strap. If the female snap button 8 fixed on the front end of the tape strip 6 is engaged with the male snap button 9 disposed at the extended end portion of the tape strip 6, a loop-like strap is formed at an end portion of the rectangular box shaped lid portion 33a as shown in FIG. 15B.

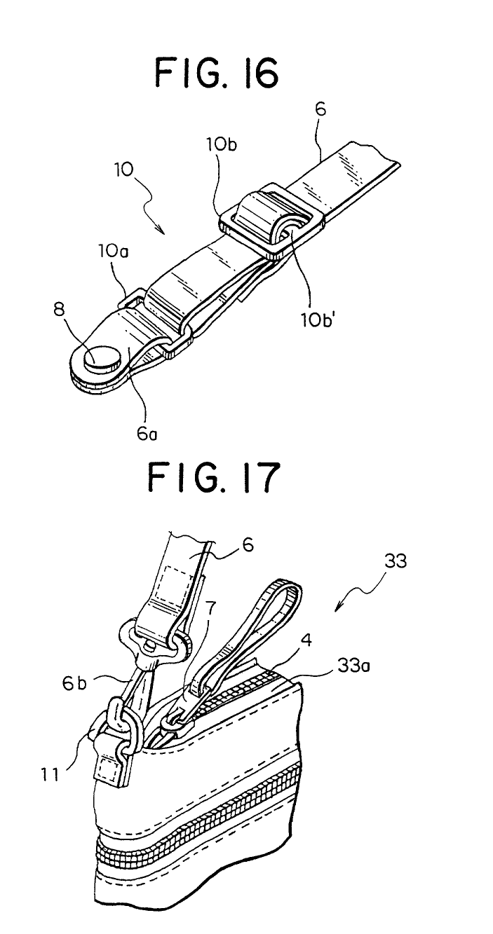

FIG. 16 shows a modified example of the tape strip 6 and a length adjusting mechanism 10 is provided on a free end portion of the same tape strip 6. This length adjusting mechanism 10 is comprised of a single rectangular ring-like metal device 10a and a substantially Θ shaped metal device 10b. The free end portion of the aforementioned tape strip 6 is divided into two sections in the longitudinal direction, and a longer side end portion thereof is inserted into the Θ shaped metal device 10b in the zigzag shape while a front end thereof is inserted into a short side portion of the rectangular ring-like metal device 10a and inverted. Further, the front end is wound around an intermediate linking lever portion 10b′ of the Θ shaped metal device 10b. On the other hand, a short side portion 6a of the divided tape strip 6 is wound around the other short side portion of the rectangular ring-like metal device 10a and folded back in the longitudinal direction, and the female snap button 8a is fixed on the overlapping end portion. By sliding the Θ shaped metal device 10bin the longitudinal direction of the tape strip 6, the length of the tape strip 6 can be adjusted arbitrarily.

FIG. 17 shows another modified example of the above-described embodiment. Instead of the male snap button 9 disposed at an end of the lid portion 33a of the accommodating body 33, part of the ring-like metal device 11 is attached while a ring 6b is attached to a free end portion of the tape strip 6. In this modified example, the tape strip 6 can be used as a shoulder belt to be mounted on an ordinary bag.

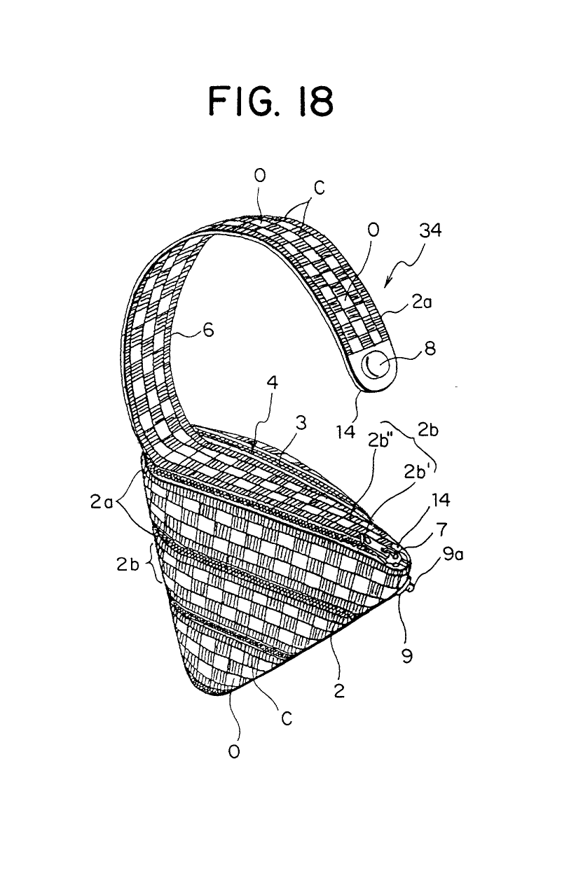

FIG. 18 shows a belt-shaped body 1, which can be obtained from the tape main body 2 and the tape strip 6 extended from the same tape main body 2. Both the tape main body 2 and the tape strip 6 are constructed of a mesh-like warp-knitted tape having larger rectangular gaps. This Figure shows a case where the formed accommodating body 34 is of a triangular pyramid shape.

According to this embodiment, the tape main body 2 and the tape strip 6 are made of a single tape material, each of which is formed by cutting a narrow fabric knitted of a mesh-like warp-knitted organization having square gaps, which is formed of mainly a generally known marquisette organization, into a desired length. The coupling elements 3 are mounted on the entire periphery of the tape main body of this tape by sewing the fastener stringer of an ordinary slide fastener, like the first embodiment.

According to this embodiment, the tape main body 2 has a stringer-sewed knitted portion 2a having fine knitting pattern on both side edges in the width direction thereof. Between both the sewed knitted portions 2a in the width direction is disposed a mesh knitted portion 2b in which square window-like gaps O obtained by entangling intersections between a lateral thread portion 2b′ and a longitudinal thread portion 2b″ are arranged vertically and horizontally in a matrix shape. Further, in this embodiment, a closed portion C is formed by closing part of the window-like gaps O which is part of the aforementioned mesh knitted portion 2b with part of tape composing threads. Therefore, the tape strip 6 also has the knitting structure of the stringer-sewed knitted portion 2a and the mesh knitted portion 2b like the tape main body 2.

Meanwhile, the central portions of the tape main body 2 and the tape strip 6 are formed in the mesh structure and a free end portion thereof is a cut end. Particularly, an end portion of the tape main body 2 is formed in an arc shape in order to allow the slider to slide smoothly to engage or disengage the coupling elements. Thus, the free end of each of the tape main body 2 and the tape strip 6 is difficult to be stabilized and in the case of the tape main body 2, the sewing strength is smaller than the other portion when the fastener stringer is fixed by sewing. If it is intended to fix the female snap button 8 on the free end portion of the tape strip 6 like the first embodiment, its fixing strength cannot be secured.

Thus, by providing a reinforcement piece 14 on each free end portion of the tape main body 2 and the tape strip 6, the configuration of the same end portion is stabilized and further, mounting strength of the fastener stringer by sewing and firm fixing strength of the female snap button 8 can be achieved.

The slide fastener stringer having the coupling elements 3 is attached annularly on the entire periphery of the tape main body 2 having the aforementioned knitting organization excluding the separating portions 3a, 3b of the belt-shaped body 1 by sewing. Then, the tape strip 6 is extended on the same plane as the tape main body 2 from an end in the longitudinal direction and by the same operation as the first embodiment, a triangular pyramid shaped article-accommodating bag 34 can be produced.

When there is no necessity of forming the article-accommodating bag 34, the slider 7 is slid toward the releasable bottom end stop 5 which is a linking member, so that the coupling is released successively. If finally, the insert pin 5a of the releasable bottom end stop 5 is released from the slider 7 and the box 5b, this bag is restored to the belt-shaped body 1, which is an original tape-like article. If this member is folded into a compact shape, it can be stored or carried conveniently.

Although according to this embodiment, the material of threads to be used in the tape main body 2 can be selected arbitrarily, ordinarily, natural fiber thread or synthetic resin fiber thread is used. As the synthetic resin fiber thread, mere multifilament, textured yarn or monofilament can be used. If rigid monofilament is used for the lateral thread portion 2b′ of the mesh knitted portion 2b in this illustrated example, stiffness in the width direction of the mesh knitted portion 2b is intensified, so that the configuration in the width direction of the tape-like article 1 can be stabilized.

The belt-shaped body 1 of this embodiment having such a structure can be folded into a compact style because it has flexibility in the longitudinal direction, so that it can be stored easily in, for example, a small bag. When it is used as an article-accommodating body 34 as described above, a product accommodated inside can be recognized easily from outside because this is almost a mesh-like structure. If the accommodating body is left at an unexpected place, its inside content can be recognized from outside easily.

Further, according to this embodiment, part of the window-like gaps O in the mesh knitted portion 2b acts as the closed portions C which are composed of part of composing threads. Thus, disposition of the closed portions C form a kind of pattern in this article-accommodating bag. Further, a product accommodated inside is difficult to be recognized from far way, and therefore, when this bag is being carried, it is not necessary to worry about attentions of other persons.

Because according to this embodiment, the main portions of the tape main body 2 and the tape strip 6 are almost composed of the mesh knitted portion 2b as described above, its entire structure is flexible. Thus, when the article-accommodating bag 34 is formed or this bag is returned to an original tape-like article 1, linking/separating operation of the linking member 5, which is a releasable bottom end stop, is facilitated. When the article-accommodating bag 34 is formed while securing the ease of handling, its configuration as the article-accommodating bag is difficult to come out of shape because some extent of stiffness is secured in the width direction of the tape-like article 1 while the flexibility is secured in the longitudinal direction of the tape-like article 1.

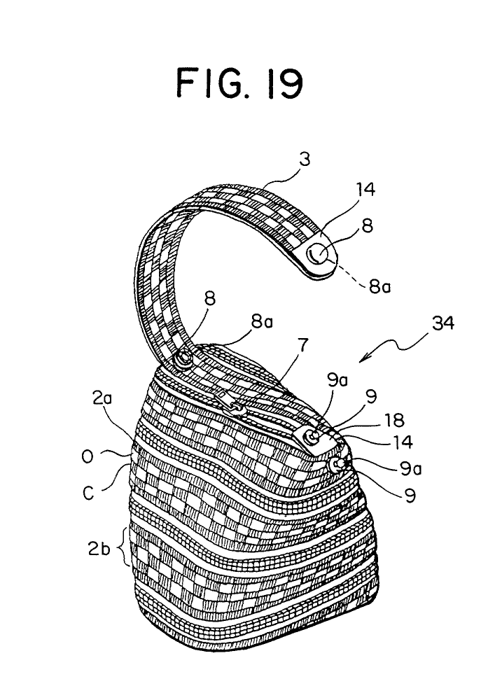

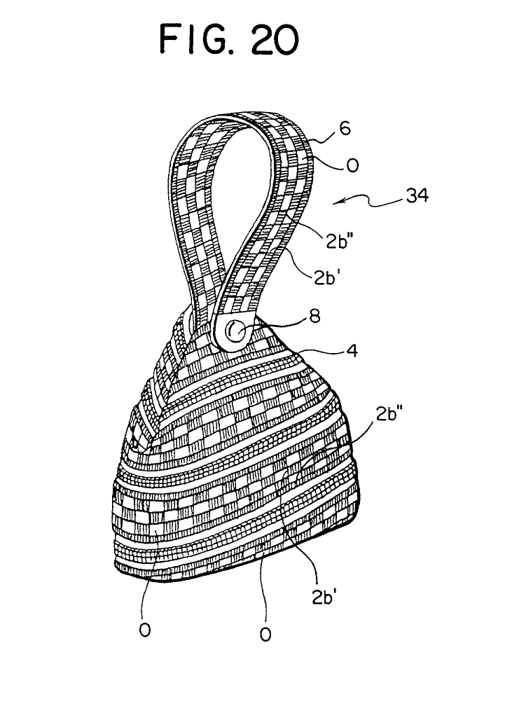

FIGS. 19 and 20 respectively show a modified example of the accommodating body 34 obtained from the belt-shaped body 1 of the above-described embodiment and its use example.

According to this modified example, the reinforcement piece 14 is used as a slider stopper of the belt-shaped body 1 and a reinforcement piece 14, which is the same as that reinforcement piece 14, is mounted at a free end portion of the tape strip 6, which is an extension member extended from the tape main body 2. These reinforcement pieces 14 have female/male snap buttons 8, 9 secured thereto so that the female engaging portion 8a and the male engaging portion 9a oppose each other when a triangular pyramid shaped accommodating body 34 is formed. Further, when the triangular pyramid shaped accommodating body 34 is formed, the female snap button 8 is mounted on the extended proximal end portion of the tape strip 6 while the male snap button 9 is mounted at a portion of the tape main body 2 near the separating portion 3a. The engaging portions 8a, 9a of the female/male snap buttons 8, 9 can be engaged with or disengaged from each other when the triangular pyramid shaped accommodating body 34 is formed.

By attaching the female/male snap buttons 8, 9 in this way, the tape strip 6 can be used as a suspending strap like the embodiment shown in FIG. 18, and when the triangular pyramid shaped accommodating body 34 is formed, by engaging the female and male snap buttons 8, 9 existing inside while engaging the female/male snap buttons 8, 9 outside, a closed loop handle strap beginning from an extensive proximal end of the tape strip 6 is formed as shown in FIG. 20.

That is, by engaging the female snap button 8 fixed on the free end of the tape strip 6 with the reinforcement piece 14 or the male snap button 9 fixed on a portion of the tape main body 2 near the separating portion 3a, the tape strip 6 can be used as a handle strap along part of the ridge of the triangular pyramid shaped accommodating body 34 for connecting the corresponding end portions. Further, if the female snap button 8 fixed on an end on the side in which the tape strip 6 of the tape main body 2 is extended is engaged with the male snap button 9 fixed on the reinforcement piece 14 while the female snap button 8 fixed on the free end portion of the tape strip 6 is engaged with the male snap button 9 fixed on the portion of the tape main body 2 located at the separating portion 3a, both the ends of the aforementioned ridge and both ends of the tape strip 6 are gathered at one place and the tape strip 6 becomes a loop-like handle strap, so that an article accommodated in the accommodating body 34 never jumps out of it unexpectedly.

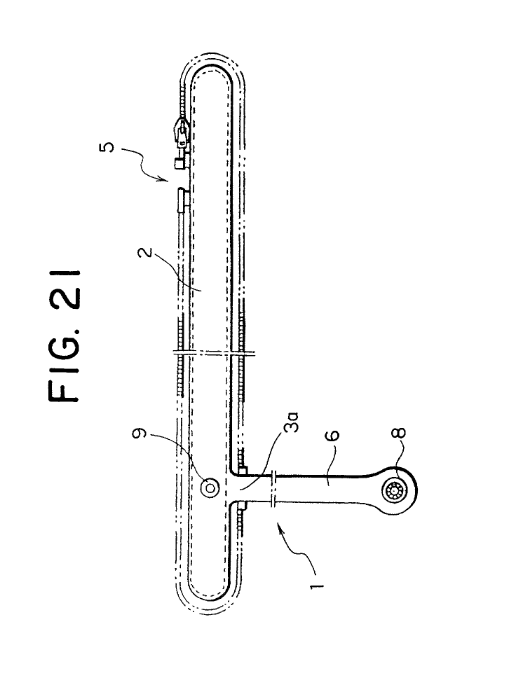

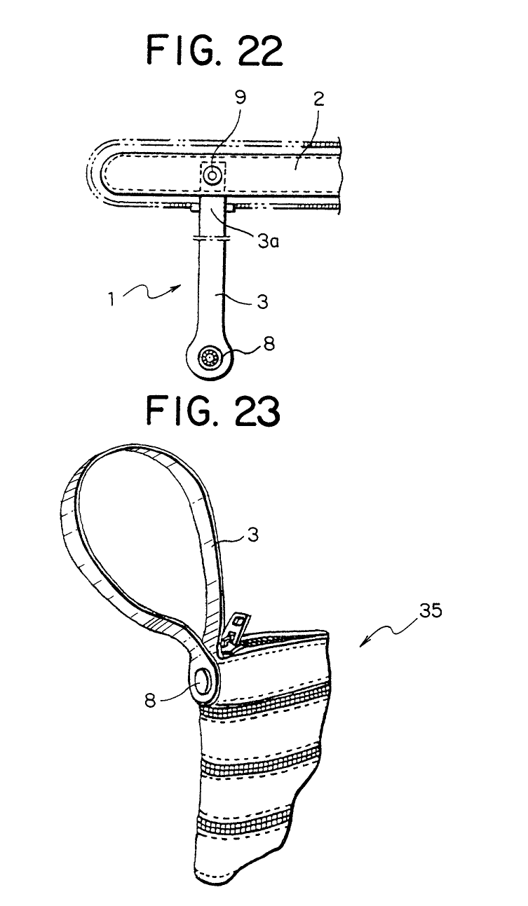

FIG. 21 is a plan view showing another embodiment of the tape-like article 1 of the present invention. According to this embodiment, the tape strip 6 which is an extension member is different from that of the first embodiment and extended at a right angle from a tape side edge of the separating portion 3a in which a linking member 5 does not exist on the periphery of the tape main body 2. Although the tape strip 6 is formed continuously directly from the tape main body 2 in this case, this embodiment should not be restricted to this example, but it is permissible to connect the tape main body 2 produced separately with an end of the tape strip 6 by for example a sewing means as shown in FIG. 22. In this embodiment also, an accommodating body 35 with a suspender, which is partially indicated in FIG. 23, can be obtained by engaging the female and male snap buttons 8, 9 in FIG. 22.

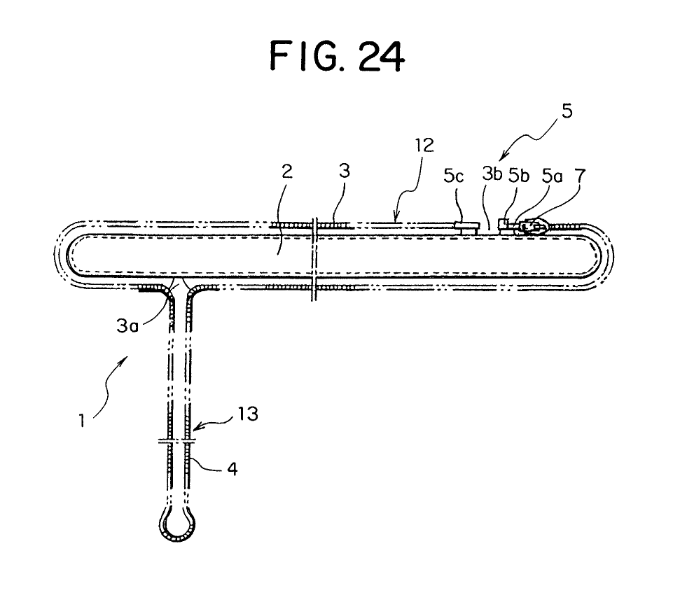

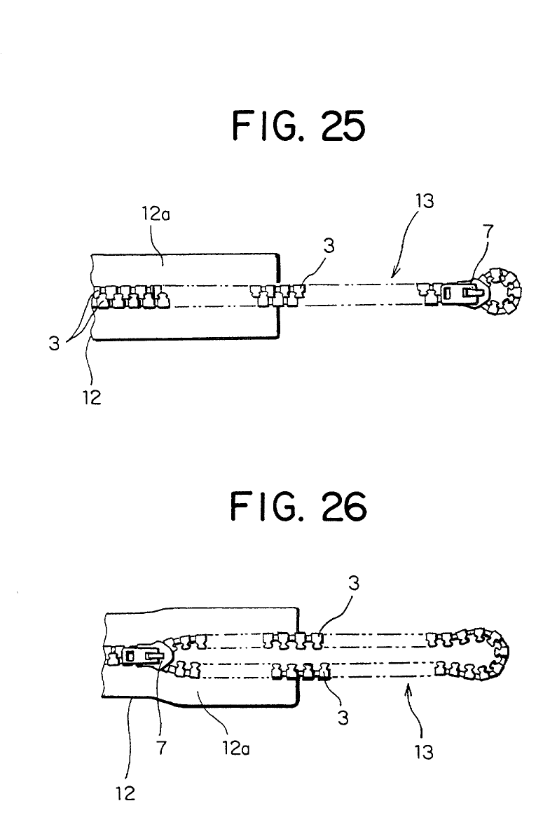

FIG. 24 is a plan view showing a further embodiment of the tape-like article 1 of the present invention. FIG. 25 is a partial plan view showing a relationship between a part of a slide fastener 12 sewed to the periphery of the tape main body 2 composing an extension member of the tape-like article 1 and an extension member 13 composed of part of the same slide fastener 12. FIG. 26 is a partial plan view showing a condition in which engagement of coupling elements of the extension member 13 is released.

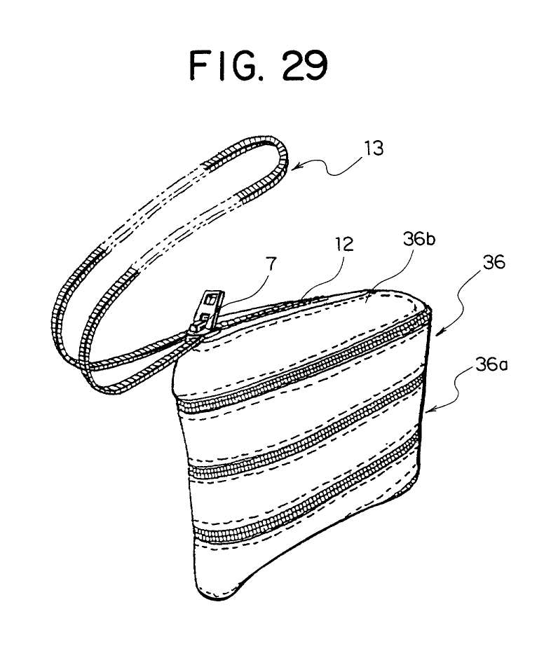

According to this embodiment, the slide fastener 12 is attached along the entire periphery of the long tape main body 2 having a required tape width and length necessary for forming a main body 36a of the accommodating body 36 shown in FIG. 29, except the separating portions 3a, 3b formed at two positions of the tape main body 2 by sewing, excluding some part of the slide fastener 12. The separating portions 3b of the separating portions 3a, 3b formed at the two positions are provided with a linking member 5 composed of a releasable bottom end stop like the above-described embodiment.

In this embodiment, part of the slide fastener stringer is extended perpendicularly to the tape main body 2 from the separating portion 3a in which the linking member 5 is not mounted, of the separating portions 3a, 3b. This extended portion is the aforementioned extended portion 13 of this embodiment. As shown in FIG. 25, the extension member 13 is composed of a string-like body in which coupling elements 3 are arranged continuously like a chain. Usually, each of coupling elements 3 in the slide fastener is fixed to side edges of two narrow fastener tapes opposing each other and is comprised of a fixing leg portion and an engaging head protruded outward of the tape side edge from the fixing leg portion. The fixing leg portions are attached by sewing or molding, or knitted or woven in at the same time when the fastener tape is woven or knitted, so that they are fixed at a predetermined pitch along the opposing side edges of the fastener tape.

According to this embodiment, a portion exposed outside from a chain portion of the slide fastener 12, extended perpendicularly from the separating portion 3a of the belt-shaped body 1, is cut out so as to form a string-like coupling element connecting member in which a plurality of the coupling elements 3 are connected continuously on a straight line as shown in FIG. 25. Then, by engaging the opposing coupling elements 3, the extension member 13 is produced. Therefore, according to this embodiment, the extended portion 13 is formed by leaving fixing portions of part of the coupling elements of the slide fastener 12 fixed on the periphery of the tape main body 2 so that this portion 13 is extended from the tape main body 2. As shown in FIG. 26, the opposing coupling elements 3 are engaged with or disengaged from each other by sliding operation of the slider 7.

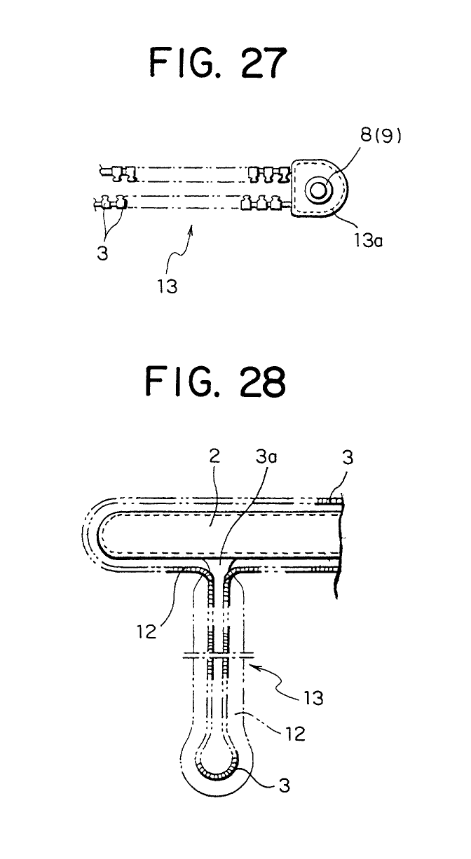

In the slide fastener 12 of this embodiment, a releasable bottom end stop 5, which is a linking member 5, is mounted on each of both ends of the slide fastener 12 so that a folded end portion when the linking member 5 is linked is formed in a loop shape. Thus, any slider stopper (top end stop) is not required as it is in an ordinary slide fastener. Meanwhile, it is permissible to form the extension member 13 using part of the ordinary slide fastener as shown in FIG. 27. In this case, by fixing a small piece 13a, which corresponds to an bottom end stop of a slide fastener, instead of the top end stop, end portions of opposing coupling-element linking members may be linked with each other, and male/female snap buttons 8, 9 may be attached on the small piece 13a. In the extension member 13, it is permissible to leave the fixing portion of the coupling elements 3 without cutting off the portion of the fastener tape 12a, which are to be cut off in the previously described example as shown in FIG. 28.

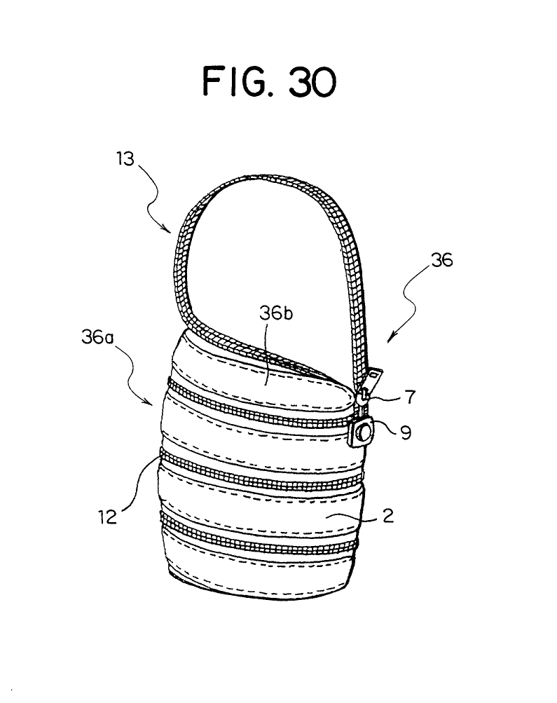

If a flat thin rectangular box type accommodating body 36 is formed using the belt-shaped body 1 obtained in such a way like the previous embodiment, the extension member 13, which is a coupling-element linking member, is extended in a loop shape from an end of its lid portion 36b so as to form a suspending strap. FIG. 30 shows a modified example of the accommodating body 36. A male snap button 9 is mounted at an end of the extension member 13 while a female snap button 8 is mounted on a portion of the tape main body 2 opposite to the extension side of the extension member 13 of the accommodating body 36. Then, if the male snap button 9 mounted on the end of the extension member 13 is engaged, a handle strap is obtained as shown in FIG. 30.

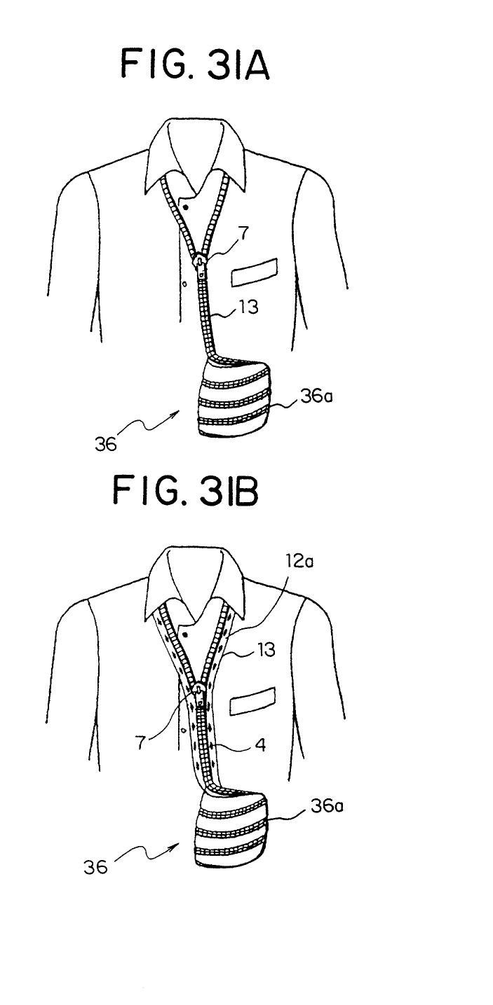

FIG. 31A and 31B show use conditions of the strap when part of the fastener tape in the extension member 13 is cut off and not cut off. According to this embodiment, when the extension member 13 is formed long, the main body 36a of the accommodating body 36 can be suspended from the neck as shown in FIGS. 31A and 31B. At this time, if the slider 7 is mounted in such a direction that when the slider 7 is slid toward a loop end, the coupling elements are engaged and when it is slid toward the accommodating body 36, engagement of the coupling elements 3 is released, the size of the loop can be adjusted arbitrarily by operating the slider 7. FIG. 31B shows a case where the fastener tape still exists on the extension member 13 and it is permissible to provide this fastener tape with ornamentation by adding patterns or the like as shown in FIG. 31B.

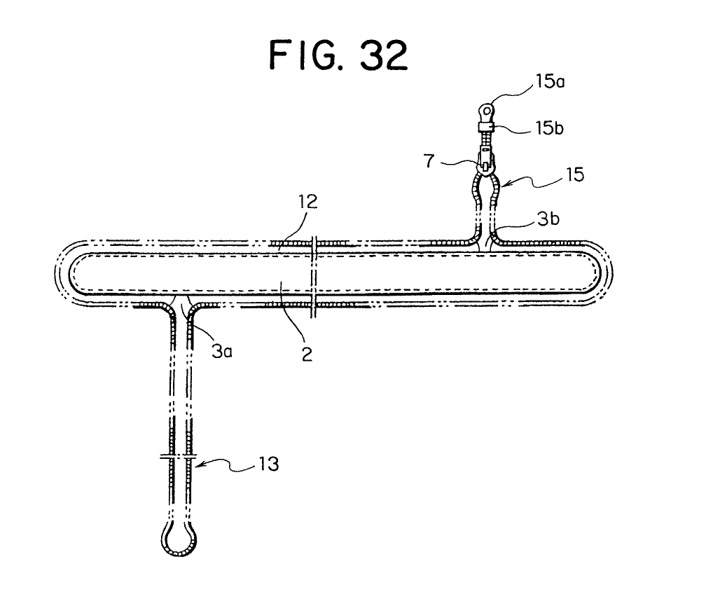

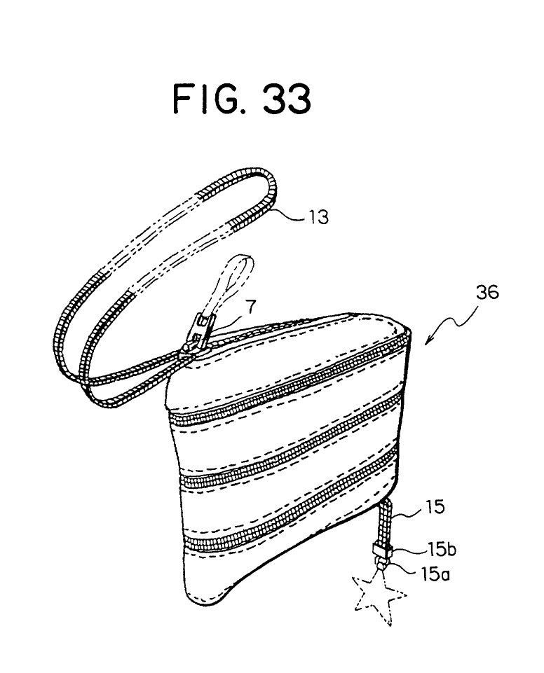

FIGS. 32 and 33 show examples of a belt-shaped body 1 according to a modified example of the previous embodiment and an accommodating body 36 formed from the same belt-shaped body 1. According to this modified example, excluding a linking member 5 composed of a releasable bottom end stop of the above-described embodiment, a second extension member 15 comprised of a pair of two second coupling-element linking members in which the coupling elements 3 are engaged continuously is extended perpendicularly from the separating portion 3b of the tape main body 2. A end stop 15b having a ring 15a for suspending an accessory or the like is fixed to an end portion of the second extension member 15 as shown in FIG. 32, so that free end portions of the two coupling-element linking members are connected. By thus extending the second extension member 15 from the separating portion 3b, the accommodating body 36 can be carried while suspending an accessory or the like from its bottom face corner as shown in FIG. 33.

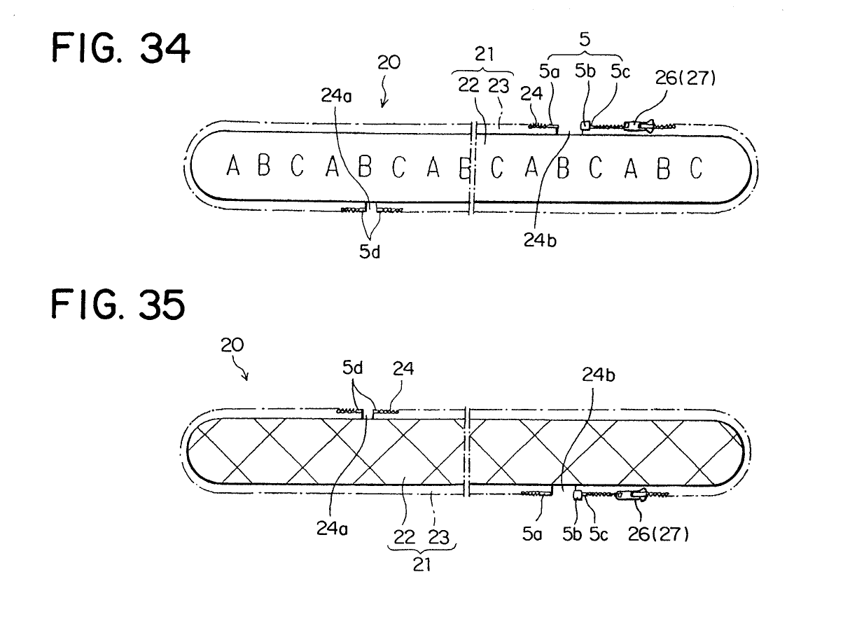

FIGS. 34 and 35 show structures of front and rear faces of a belt-shaped body 20 according to a further embodiment of the present invention.

A belt-shaped body 20 of this embodiment in which a plurality of coupling elements 24 are fixed on the periphery of a tape 21 is comprised of a tape main body 22 each of which end in the length direction is cut in an arc shape, a pair of coupling-element-mounting tapes 23 sewed along the periphery up to two separating portions 24a, 24b of the tape main body 22 and a plurality of the coupling elements 24 fixed at equal pitches along the outer periphery of each coupling-element-mounting tape 23.

In addition to the structure described above, in the belt-shaped body 20 of this embodiment, front and rear faces of the tape 21, which is a prominent feature of the present invention, are provided with different patterns or coloring. Such a pattern or color can be provided to the front and rear faces of the tape 21 by a printer or weaving or knitting. Further, in addition to the structure relating to the pattern or coloring, the front and rear faces of the belt-shaped body 20 have the same structure.

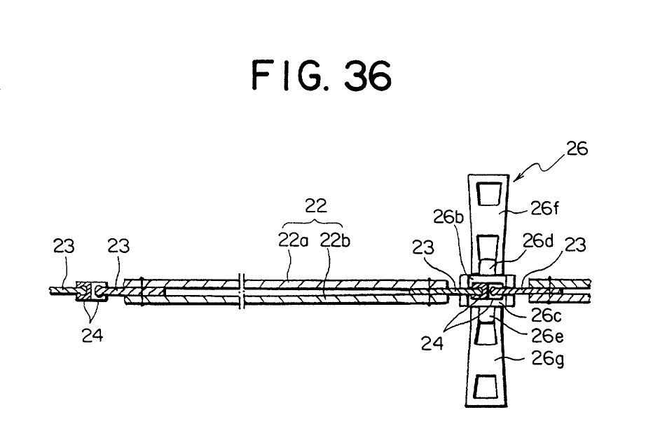

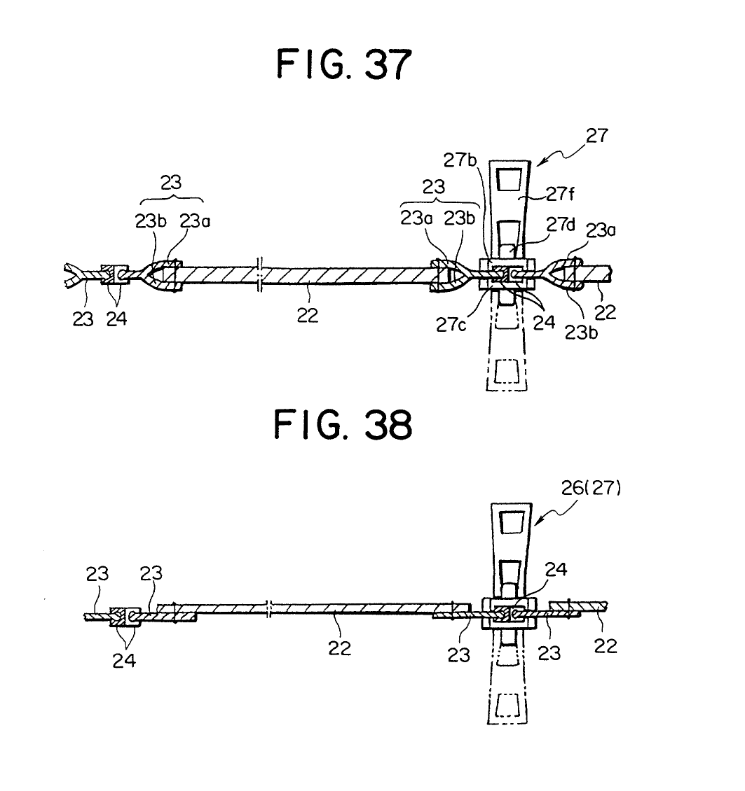

FIGS. 36 and 37 schematically show two examples in which the front and rear faces of the belt-shaped body 20 are of the same structure.

In the example shown in FIG. 36, a pair of the coupling-element-mounting tapes 23 on which the aforementioned coupling elements 24 are fixed are formed of a single tape material and the tape main body 22 is comprised of two tape materials 22a, 22b, which have the same dimensions and shapes while patterns or colors exposed outside are different. The two tape materials 22a, 22b are overlapped with each other such that their pattern faces are exposed outside. Each of the coupling-element-mounting tapes 23 are sequentially sewed via the separating portions 24a, 24b in a sandwiched state by the peripheral portion of the tape materials 22a, 22b which are overlapped with each other, thereby the tape 21 is formed. Because, with such a structure of the tape 21, the structures of the front and rear surfaces are equal, it is difficult to recognize a difference between the front and rear surfaces except the difference of the patterns while both the front and rear surfaces can be finished beautifully.

Meanwhile, in this case, patterns and colors of the front and rear surfaces of the coupling-element-mounting tape 23 may be different from each other. Further, the coupling-element-mounting tape 23 may not be composed of a single tape material, but may be formed by binding together two tape materials each having a different pattern or color exposed outside.

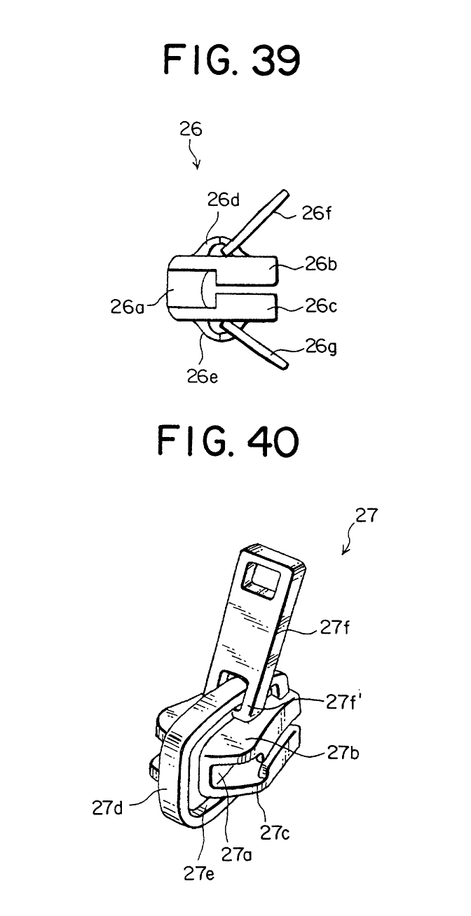

In a slider 26 to be mounted on the coupling-element-mounting tape 23 of this embodiment, as shown in FIG. 39, mounting rings 26d, 26e of the same structure are provided on outer surfaces of two blades 26b, 26c whose ends are joined through a linking column 26a. Pulls 26f, 26g are attached to the respective mounting rings 26d, 26e. With such a structure, by using any one of the two pulls 26f, 26g depending on the purpose, this slider 26 can engage or disengage the coupling elements 24 of the belt-shaped body 20 smoothly both through the front and rear surfaces.

In an example shown in FIG. 37, on the other hand, the tape main body 22 is composed of a single tape material in which patterns and colors of front and rear surfaces thereof are different and the coupling-element-mounting tape 23, on which the coupling elements 24 are fixed, is comprised of tape materials 23a, 23b which are branched in a Y shape in its cross section on one edge portion which no coupling elements 24 are fixed. Then, the two tape materials 23a, 23b sandwich the peripheral portion excluding the separating portions 24a, 24b on the periphery of the tape main body 22 and by sewing together the overlapping portion, the tape 21 is formed.

Because, with such a structure, the structures of the front and rear surfaces are equal, it is difficult to recognize a difference between the front and rear surfaces except for the difference of the patterns while both the front and rear surfaces can be finished beautifully.

Although the above-described coupling-element-mounting tape 23 has a cross section which is branched in the Y shape, the present invention should not be restricted to this example, but it is permissible to form the tape by binding together two tape materials produced separately along the entire width of the coupling-element-mounting tape 23. Further, the tape main body 22 may be also formed by binding together two tape materials each having a different pattern or color exposed outside.

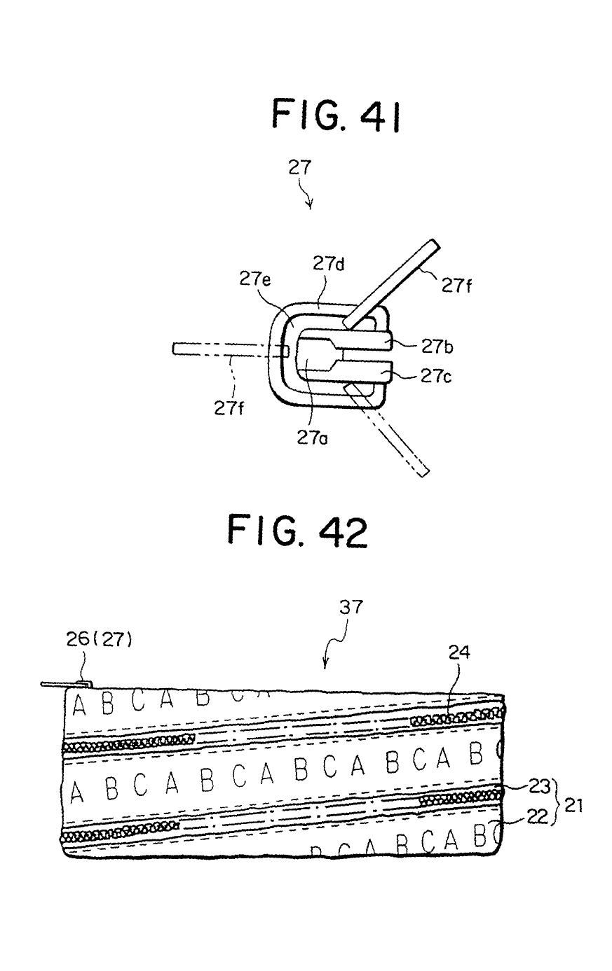

In the slider 27 to be mounted on the coupling-element-mounting tape 23 of this example, as shown in FIG. 40, a pull mounting member 27d having a T-shape cross section and formed in a horizontal U-shape is fixed on the front and rear surfaces of two blades 27b, 27c whose ends are connected through the linking column 27a, such that it rides over the linking column 27a. A sliding leg portion 27f′ of a pull 27f is engaged slidably in a pull-sliding-guide groove 27 formed between the pull mounting member 27d and the front/rear surfaces of the blades 27b, 27c. In this slider having such a structure, the pull 27f can be moved to the front or rear surface of the two blades 27b, 27c as indicated with a solid line and a phantom line in FIG. 41, so that the coupling elements 24 of the belt-shaped body 20 can be engaged or disengaged smoothly through both the front and rear surfaces. Meanwhile, this slider 27 may be applied to the embodiment shown in FIG. 36.

FIG. 38 shows schematically an example in which the structures of the front and rear surfaces of the belt-shaped body 20 are different from each other. That is, the coupling-element-mounting tape 23 having the coupling elements 24 secured thereto is composed of a single tape material and the tape main body 22 is also composed of a single tape material in which the patterns and colors of the front and rear surfaces thereof are different. Then, the coupling-element-mounting tape 23 is placed on a top face of the periphery of the tape main body 22 except the separating portions 24a, 24b and this overlapping portion is sewed so as to form the tape 21. With such a structure of the tape 21, the front and rear surfaces come to have different structures and further, not only patterns and colors of the front and rear surfaces of the tape main body 22 are different from each other, but also the front and rear surfaces can be finished in diversified appearances, which are different.

Meanwhile, the sliders 26, 27 may be applied to this embodiment.

If a different pattern or color is applied to each of the front and rear surfaces of the coupling-element-mounting tape 23 on which the coupling elements are fixed by for example, dyeing by means of an ink jet in the respective examples shown in FIGS. 37 and 38, a belt-shaped body 20 provided with diversified patterns, colors or various kinds of logo marks can be obtained with changes in the pattern and colors of the tape main body 22. Further, it is permissible to overlap two tape materials on the tape main body 22 or the coupling-element-mounting tape 23 so as to be used as a single tape material.

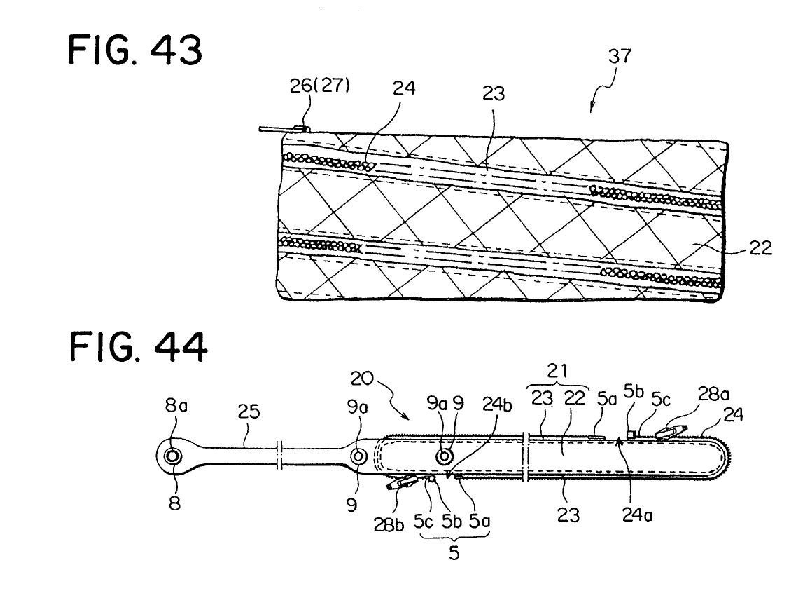

FIGS. 42 and 43 show appearances of accommodating bodies 37 formed by inverting the front and rear surfaces of the belt-shaped body 20 of the above described embodiment. In order to expose the front face shown in FIG. 34 outside, the tape main body is folded from the front side to the rear side at the center of the separating portion 24a in which the releasable bottom end stop 5 is disposed, and by inserting the insert pin 5a of the releasable bottom end stop 5 into the slider 26 (27) disposed to oppose this and then inserting into the box 5b, the insert pin 5a and the box pin 5c are linked with each other. After that, by sliding the slider 26 (27) while winding the belt-shaped body 20 around the releasable bottom end stop 5, a rectangular thin box type accommodating body 37 whose letter pattern is exposed on its front surface is obtained. If it is intended to expose a grid pattern on the rear side on the front surface of the accommodating body 37, the tape main body 22 is folded from the rear side to the front side at the separating portion 24a and the engaging operation of the coupling elements 24 by means of the slider 26 (27) is carried out in the same manner as described above. Consequently, the accommodating body 37 whose grid pattern is exposed on the surface thereof is formed as shown in FIG. 43. In the accommodating body 37 formed in this case, the direction of winding the belt-shaped body 20 is opposite to that of the accommodating body 37 shown in FIG. 42.

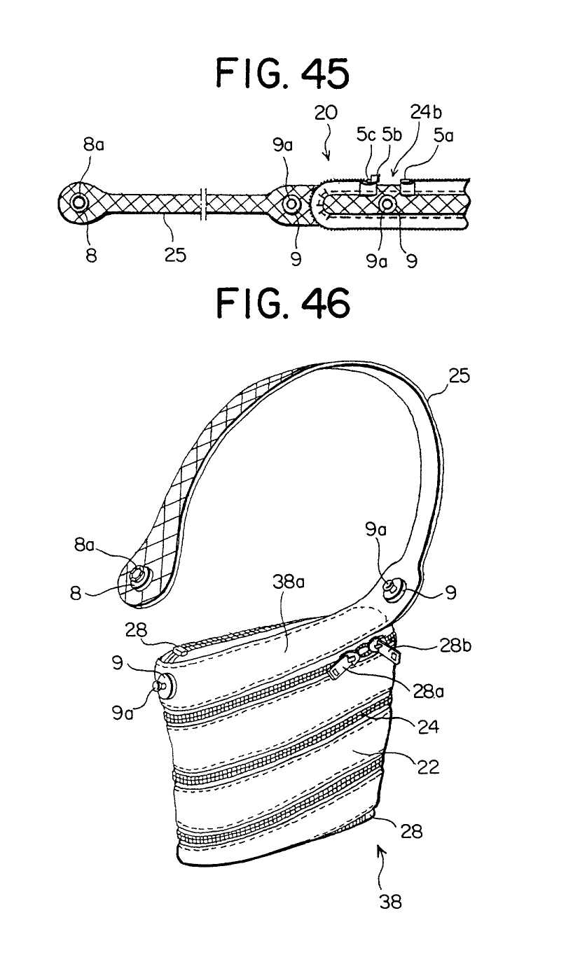

FIG. 44 is a top view of a belt-shaped body 20 of another embodiment of the present invention. FIG. 45 is a partial rear view of the same belt-shaped body 20. According to this embodiment, an extension member 25 is extended integrally from an end of a tape main body 22 which composes a tape 21. Although this extension member 25 can be formed of a tape material produced separately from the tape main body 2, according to this embodiment, the separate extension member 25 is not fixed to an end of the tape main body 2 but the tape main body 22 and the extension member 25 are produced integrally using a single tape material.

In the tape main body 22 and the extension member 25 of this embodiment, the patterns and colors of their front and rear surfaces are different. Further, the width of the tape of the extension member 25 is smaller than the tape width of the tape main body 22 except its front end. Of course, the tape widths of the tape main body 22 and the extension member 25 can be equalized. Because according to this embodiment, as described above, the tape main body 22 and the extension member 25 are formed continuously of a single tape material, a coupling-element-mounting tape 23 in which coupling elements 24 are fixed on a side edge thereof is sewed annularly on substantially the entire periphery of the tape main body 22 excluding two separating portions 24a, 24b, which is an accommodating body forming region. Therefore, as shown in FIGS. 44 and 45, the extension member 25 is extended independently outside the coupling-element-mounting tape 23.

The coupling elements 24 are equal to coupling elements applied to an ordinary slide fastener and a tape portion of the coupling-element-mounting tape 23 in which the coupling elements 24 are fixed is sewed along a side edge of a fastener tape of the slide fastener except two separating portions 24a, 24b. A releasable bottom end stop 5 is fixed on each of the separating portions 24a, 24b. Two sliders 28a, 28b for engaging or disengaging the coupling elements 24 are respectively mounted slidably on a pair of the coupling-element-mounting tape 23 disposed via the separating portions 24a, 24b such that their opening portions opposite to the linking columns are directed toward a box 5b of each releasable bottom end stop 5.

The two sliders 28a, 28b employ a structure enabling themselves to be operated in the same manner as the sliders 26, 27 already described.

The extension member 25 is extended directly from the other end of the tape main body 22 as described above. A female snap button 8 which is a female engaging/disengaging member is fixed on a front end of the extension member 25 such that its female engaging/disengaging portion 8a is exposed on the front and rear surfaces of the tape. Then, a male snap button 9, which is a male engaging/disengaging member, is fixed on a border region between the extension member 25 and the tape main body 22 such that its male engaging/disengaging portion 9a is protruded from the front/rear surfaces of the tape. Additionally, the male snap button 9, which is a male engaging/disengaging member, is fixed at a portion adjacent the separating portion 24b of the tape main body 22 such that its engaging/disengaging portion 9a is protruded from the front and rear surfaces of the tape.

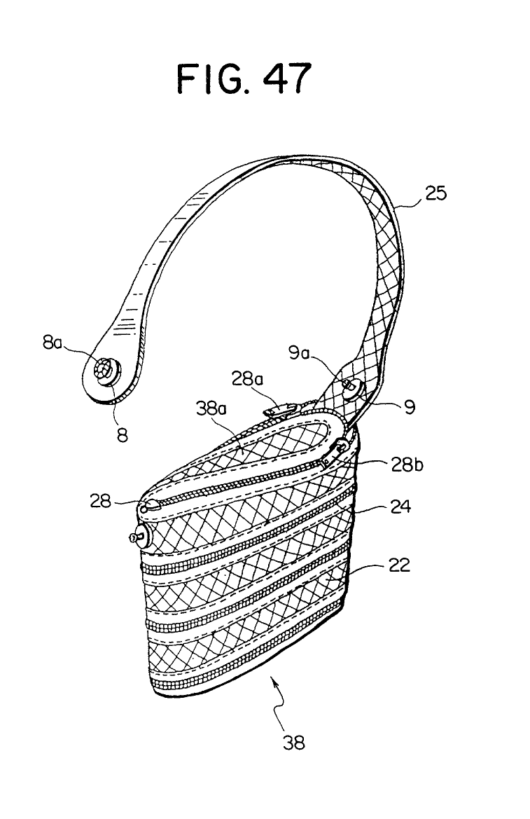

FIGS. 46 and 47 show an example of an accommodating body 38 made from the belt-shaped body 20 having such a structure. FIG. 46 is a perspective view of the entire accommodating body as viewed from an end side of the lid portion 38a. FIG. 47 is a perspective view of the entire accommodating body as viewed from an end side of the lid portion 38a. In the aforementioned accommodating body 38, an insert pin 5a of the releasable bottom end stop 5 fixed to one separating portion 24b is inserted into the slider 28a and subsequently, is inserted into a box 5b so as to combine a box pin 5c with the insert pin 5a. After that, while winding the belt-shaped body 20 spirally around the releasable bottom end stop 5, the slider 28a is slid so as to join the corresponding coupling elements 24.

As shown in FIG. 46, the slider 28a is slid up to just before an end portion on the extension side of the extension member 25 so as to engage the coupling elements 24 on a side edge of the lid portion 38a. The insert pin 5a of the releasable bottom end stop 5 fixed to the other separating portion 24b is inserted into the slider 28b and at the same time, inserted into the box 5b, so that the box 5a and the insert pin 5c are linked together. After that, the slider 28b is slid on the other side edge of the lid portion 38a as shown in FIG. 46 and subsequently passed along an end portion on the extension side of the extension member 25, so that the slider 28b opposes the slider 28a. Consequently, substantially all the coupling elements 24 are engaged.

In the illustrated example, the accommodating body 38 has a flat thin rectangular box shape and the aforementioned snap button 9 is disposed on one end portion of its upper lid portion 38a and the other male snap button 9 is disposed at a proximal end portion of the extension member 25. The female snap button 8 is disposed at a front end portion of the extension member 25 extended directly from the lid portion 38a of the accommodating body 38. If it is intended to use this extension member 25 as a handle strap, the female snap button 8 fixed to the front end of the extension member 25 is engaged with the male snap button 9 disposed at an end of the lid portion 38a

Two sliders 28a, 28b are disposed on one side edge of the lid portion 38a such that they oppose each other. If either one or both of the two sliders 28a, 28b are slid in a direction that they separated from each other so as to release the coupling elements in the lid portion 38a, a accommodated article can be taken out or into the accommodating body 38.

The accommodating body 38 is formed such that a top face of the belt-shaped body 20 shown in FIG. 44 is exposed outside. In the case of this embodiment, by exposing the rear face of the belt-shaped body 20 shown in FIG. 45 to the front side, the accommodating body 38 having a different surface pattern as shown in FIG. 47 can be formed.

In this case, the insert pin 5a of the releasable bottom end stop 5 fixed to one separating portion 24a is inserted into the slider 28a and at the same time, inserted into the box 5b so as to link the box pin 5c with the insert pin 5a. After that, while the belt-shaped body 20 is wound spirally around the releasable bottom end stop 5, one slider 28a is slid to engage corresponding coupling elements 24. Then, the slider 28a is slid up to just before the extension end portion of the extension member 25 as shown in FIG. 47 so as to engage the coupling elements 24 on one side edge of the lid portion 38a. Then, while the insert pin 5a of the releasable bottom end stop 5 fixed to the other separating portion 24b is inserted into the slider 28b and at the same time, inserted into the box 5b so as to link the box pin 5c with the insert pin 5a. After that, as shown in FIG. 47, the slider 28b is slid up to just before the extension end portion of the extension member 25 beyond the other side edge of the lid portion 38a, so as to engage the coupling elements 24 on the other side edge of the lid portion 38.

Because according to this embodiment, the female and male snap buttons 8, 9, which are female and male engaging/disengaging members mounted on the belt-shaped body 20, are so constructed that their engaging/disengaging portions 8a, 9a are protruded from the front and rear surfaces, a front end of the extension member 25 may be engaged with an end portion of the lid portion 38 of the accommodating body 38 so as to form a handle strap even in the accommodating body 38 obtained by inverting the belt-shaped body 20 as described above.

If it is intended to take any article out of or into this accommodating body 38, any one of the two sliders 28a, 28b is slid in such a direction that it separates from an extended end portion of the extension member 25 so as to release the coupling elements.

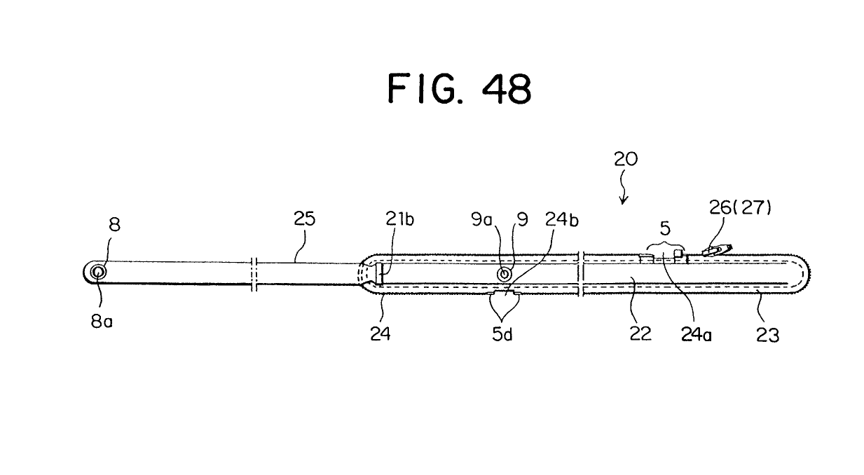

FIG. 48 is a top view of a belt-shaped body 20 according to another embodiment of the present invention.

This embodiment is different from the previous embodiment in that (1) the tape main body 22 and the extension member 25 are formed of a single tape material whose exposed surface has a different color or pattern and sandwiched between two overlapping coupling-element-mounting tapes 23 so that they are sewed together, (2) the male snap button 9 mounted on the proximal end portion of the extension member 25 is excluded, (3) the slider 26 mounted on the coupling-element-mounting tape 23 is singular and therefore, the releasable bottom end stop 5 is singular while the top end stop 5d of the slide fastener is mounted to the other separating portion 24b and (4) a long extension-member-insertion slit 21b is formed in the tape width direction in the extension end portion of the extension member 25 of the tape main body 22.

Although a single tape material is used in the above-described example, the present invention should not be restricted to this example, but two pieces of the tape materials may be overlaid as shown in FIG. 36.

A point that the extension-member-insertion slit 21b is formed is a prominent feature of this embodiment. The other configuration is substantially the same as the previous embodiment.

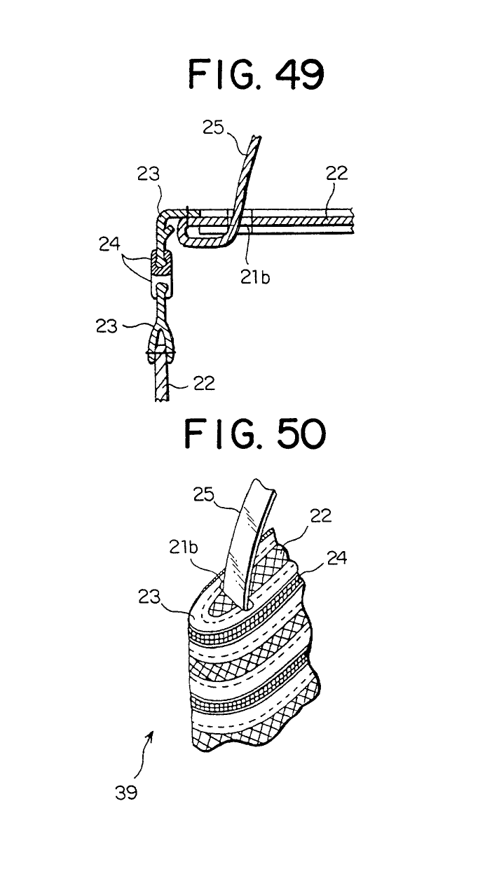

FIGS. 49 and 50 schematically show a partial structure of an accommodating body 39 obtained by exposing a rear side of the belt-shaped body 20 having the above-described structure. FIG. 49 is a sectional view of a corner portion from which the extension member 25 of the accommodating body 39 is extended and FIG. 50 is an appearance view thereof.

If the accommodating body 39 is formed with the top face shown in FIG. 50 being exposed by using the belt-shaped body 20, the extension member 25 is formed such that it is extended from a corner of the accommodating body 39 as an extension of the tape main body 22 in the same manner as in the previous embodiment. If the accommodating body is formed with the rear side of the belt-shaped body 20 being exposed at the rear, the extension member 25 happens to be extended into the inside of the accommodating body. Thus, in this embodiment, a long extension-member-insertion slit 21b is formed in the tape width direction in the extension end portion of the extension member 25 of the tape main body 22 as described above, so that as shown in FIGS. 49 and 50, the extension member 25 extended into the inside of the accommodating body 39 may be pulled out through the extension-member-insertion slit 21b.

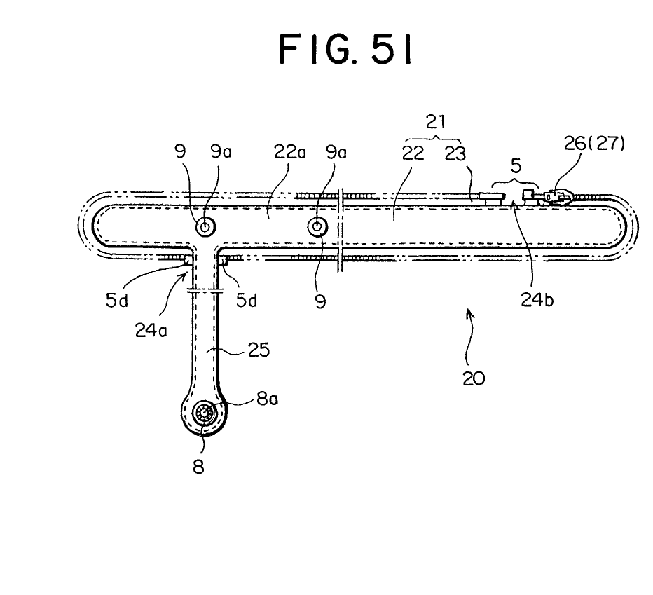

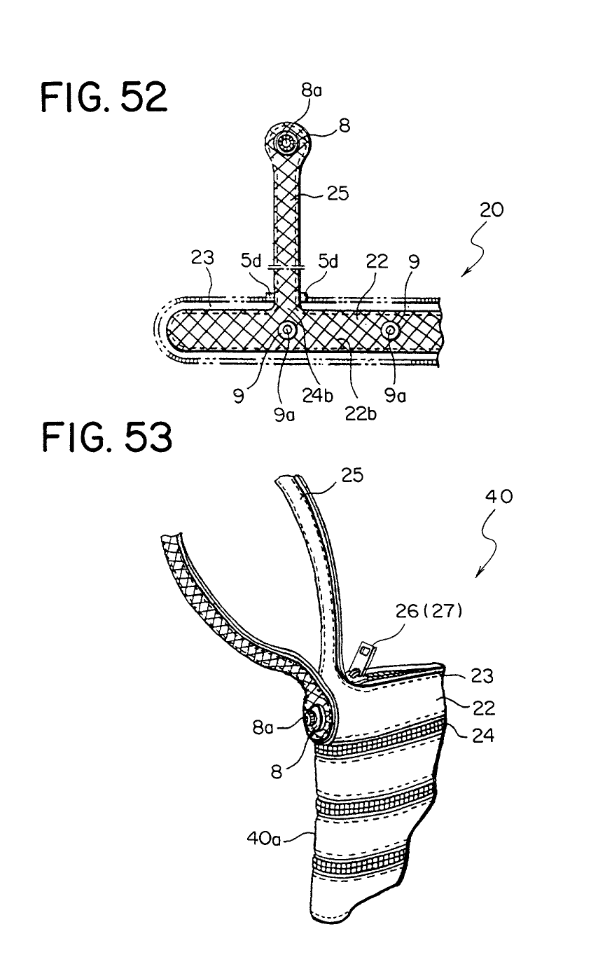

FIG. 51 is a top view showing another embodiment of the belt-shaped body 20 of the present invention. FIG. 52 is a rear view of an extension side end portion of the extension member 25 of the same belt-shaped body 20.

According to this embodiment, the coupling-element-mounting tape 23 is sewed along the entire periphery of the long tape main body 22 having a necessary width and length for forming the main body 40a of the accommodating body 40 shown in FIG. 53, except two separating portions 24a, 24b. Like the previous embodiment, a releasable bottom end stop 5 is mounted to one separating portion 24a of the separating portions 24a, 24b formed at two positions and a tope end stop 5d is mounted on the other separating portion 24b.

According to this embodiment, the extension member 25 is produced by cutting out a single tape material together with the tape main body 22, such that it is extended perpendicularly in the length direction from the separating portion 24b having no releasable bottom end stop 5 of the separating portions 24a, 24b. According to this embodiment also, the tape main body 22 and the extension member 25 are formed of two tape materials 22a, 22b whose outside surfaces have different colors or patterns. Then, the coupling-element-mounting tape 23 is sandwiched by the peripheries of the two overlaid tape materials 22a, 22b, so that they are sewed together.

The male snap button 9 is attached in the vicinity of the separating portion 24b from which the extension member 25 of the tape main body 22 is extended and at a predetermined position such that its engaging/disengaging portion 9a is protruded from the front and rear sides, while the female snap button 8 is mounted on a front end of the extension member 25 such that its engaging/disengaging portion 8a is protruded from the front and rear faces.

If the same operation as the embodiment shown in FIG. 34 is carried out while a top face or a rear face of the belt-shaped body 20 obtained in this way is exposed outside, a flat, rectangular box type accommodating body 40 shown in FIG. 53 is formed and the extension member 25 is extended from an end on the top side of the accommodating body 40. By engaging the female snap button 8 on the front end with the male snap button 9 mounted on the main body 40a of the accommodating body 40, a suspending strap can be formed.

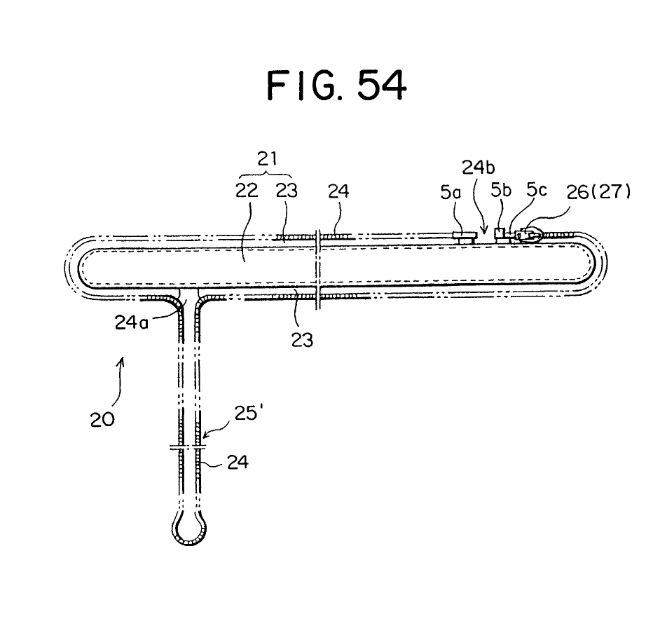

FIG. 54 shows a belt-shaped body 20 according to another embodiment of the present invention, in which a loop-like string body 25′ is extended as an extension member from a separating portion 24a of a tape main body 22 composed of a tape 21 having the same structure as the above-described embodiment. This string body 25′ is obtained by extending the coupling-element-mounting tape 23 sewed along the periphery of the tape main body 22 from the separating portion 24b. However, in this case, the coupling-element-mounting tape 23 is not simply extended just as it is, but the loop-like stripe body 25′ is obtained by while keeping a tape portion in which the coupling elements are connected at equal pitches, cutting out the other tape portion. In this embodiment, the strip body 25′ is used as a shoulder strap or a neck strap to carry this accommodating body.

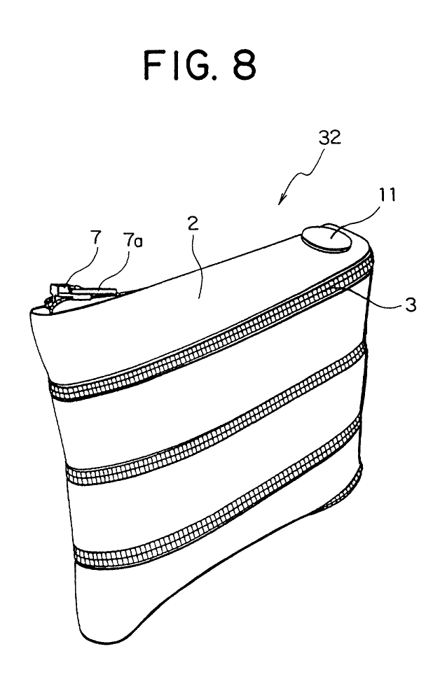

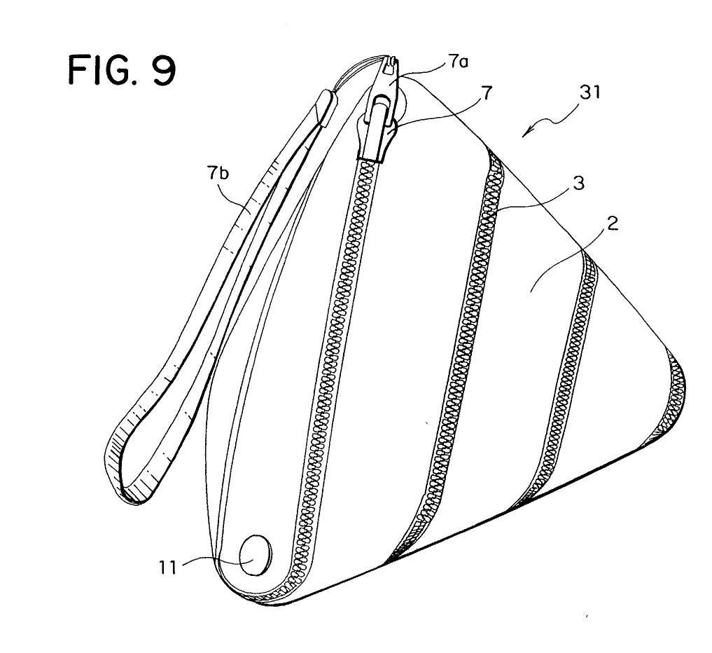

If the accommodating body obtained in this way is a triangular pyramid accommodating body 31 shown in FIG. 9, it can carry a small article such as cosmetics inside and if it is a rectangular accommodating body 32, it can be used as an accommodating case for a small camera, mobile phone or tobacco (FIG. 8). If it is a vertically long cylindrical accommodating body though its illustration is omitted, it can be used as an accommodating case for a digital camera, mobile phone, foldable umbrella or glasses.

What is claimed:

1. A belt-shaped body in which separating portions are provided at two positions on a periphery of a long tape main body while a plurality of coupling elements which can be engaged or disengaged are fixed along an entire periphery except said positions,
wherein when a tape width of said tape main body is W, dimension from a first coupling position center of said coupling elements up to an end face in the length direction of the tape main body near said position is a′ and the number of tape windings except top/bottom faces is N, a length L′ in a length direction of the tape main body between end faces thereof is obtained according to a following expression (I):
$${L}^{′} = ( 1 + \frac{α}{100} ) [ K \{ \frac{{a}^{′}}{βcos ( {tan}^{- 1} \frac{ωβ}{{a}^{′}} )} - AT \} - 2 NBW ] \qquad ( I )$$
where α is a contraction coefficient of tape main body when the coupling elements are mounted;
β is a correction value;
K is a value determined depending on a configuration of an article-accommodating body obtained from the belt-shaped body;
T is a dimension between linking members at a first linkage position;
A is (2−π)/2π; and
B is (2−π)/4.

2. A belt-shaped body according to claim 1, wherein the value K determined depending on the configuration of the article-accommodating body obtained from said belt-shaped body is obtained according to a following expression (IV):
K=X+2N (IV)
Where X is 1.5 or 2.

3. A belt-shaped body in which separating portions are provided at two positions on a periphery of a long tape main body while a plurality of coupling elements which can be engaged or disengaged are fixed along an entire periphery except said positions,
wherein when a tape width of tape main body is W and a lateral length of a side of an article-accommodating body obtained from said belt-shaped body as viewed from its front is a, a distance a′ from a center of said separating portions up to an end face of the tape main body near the center of said separating portions and a necessary tape main body length L′ are obtained according to following expressions (II) and (III):
a′=βa (II)
L′=(1+α/100)(XD+2NE)a (III)
Where α is a contraction coefficient of the tape main body when coupling elements are mounted;
β is a correction value;
N is the number of windings excluding top/bottom faces of an article-accommodating body;
D and E are constants;
X is 1.5 or 2; and 0<W<a

4. A belt-shaped body according to claim 1 or 3, wherein a contraction coefficient a of the tape main body when said coupling elements are mounted is 0 to 6.0%.

5. A belt-shaped body according to claim 1 or 3, wherein the contraction coefficient α of said tape main body is a contraction coefficient which occurs when a tape strip having the coupling elements is sewed thereto and said contraction coefficient α is 0.2 to 6.0%.

6. A belt-shaped body according to claim 4 or 5, wherein said correction value β is 1.01 to 1.20.

7. A belt-shaped body according to claim 1 or 3, wherein an interval V between opposing side edges of the tape main body when the coupling elements are engaged is in a range between 5 mm or more and 20 mm or less.

8. A belt-shaped body according to claim 3, wherein said constant D is 1.00 to 1.20.

9. A belt-shaped body according to claim 3, wherein said constant E is 1.07 to 1.50.

10. A belt-shaped body according to claim 1 or 3, wherein an extension member is extended from part of the periphery of said tape main body.

11. A belt-shaped body according to claim 10, wherein while one engaging/disengaging device is provided at a front end of said extension member, the other engaging/disengaging member which engages or disengages from said one engaging/disengaging device is provided at a desired position of said tape main body and/or the extension member.

12. A belt-shaped body according to claim 10 or 11, wherein said extension member is formed of a tape strip extended from a side edge of said separating portion on the periphery of said tape main body.

13. A belt-shaped body according to claim 10, wherein said extension member is formed of the same material as said tape main body.

14. A belt-shaped body according to claim 10, wherein the width of said extension member is smaller than a tape width of said tape main body except at least a front end thereof.

15. A belt-shaped body according to claim 10, further comprising length adjusting means capable of adjusting a length of said extension member.

16. A belt-shaped body according to claim 10, wherein said coupling elements are fixed along the periphery of said tape main body through a narrow tape.

17. A belt-shaped body according to claim 16, wherein said extension member is composed of a pair of narrow coupling-element linking members formed by extending said narrow tape having the coupling elements while said coupling-element linking member is composed of a slide fastener stringer.

18. A belt-shaped body according to claim 1, 3 or 10, wherein front and rear surfaces of said tape main body have different patterns or colors.

19. A belt-shaped body according to claim 1, 3 or 10, wherein said coupling elements are fixed along the periphery of said main tape body through a narrow tape, and the front and rear surfaces of said narrow tape have different patterns or colors.

20. A belt-shaped body according to claim 19, wherein front surfaces of said tape main body and said narrow tape have the same patterns or colors while rear surfaces thereof have different patterns or colors from the front surfaces.

21. A belt-shaped body according to claim 19 or 20, wherein said tape main body and said narrow tape are composed of at least a single tape material while a periphery opposite to coupling-elements-fixing side periphery of said narrow tape is fixed on a periphery of any of the front and rear surfaces of said tape main body.

22. A belt-shaped body according to any one of claims 19 to 21, wherein said tape main body is composed of two tape materials and said narrow tape is composed of at least a single tape material, while peripheries of said two tape materials sandwich a periphery opposite to a coupling-elements-fixing side of said narrow tape.

23. A belt-shaped body according to any one of claims 19 to 21, wherein said tape main body is composed of at least a single tape material and a periphery at least opposite to a periphery of coupling-elements-fixing side of said narrow tape is composed of two tape materials while said two tape materials sandwich the periphery of said tape main body.

24. A belt-shaped body according to claim 1 or 3, wherein said tape main body is composed of fiber knitted/woven fabric having a fine knitting/weaving density.

25. A belt-shaped body according to claim 1 or 3, wherein said tape main body is composed of fiber knitted/woven fabric partially having a mesh portion of a rough knitting/weaving density.

26. A belt-shaped body according to claim 1 or 3, wherein said tape main body is composed of leather or the like.

27. A belt-shaped body according to claim 1 or 3, further comprising engaging/disengaging means for engaging/disengaging said coupling elements by sliding operation toward front ends of said pair of coupling elements.

28. A belt-shaped body according to claim 27, wherein said engaging/disengaging means for coupling elements has a structure allowing itself to be operated from both front and rear surfaces thereof.

29. An article-accommodating body, wherein it can be obtained by successively engaging the coupling elements of the belt-shaped body according to claim 1, 3, 10 or 18.
